(19) United States
(12) Patent Application Publication
(10) Pub. No.: US 2025/0180879 A1
(43) Pub. Date: Jun. 5, 2025

(54) IMAGING LENS, RECOGNITION DEVICE, AND INFORMATION PROCESSING APPARATUS

(71) Applicant: Lenovo (Singapore) Pte. Ltd., Singapore (SG)

(72) Inventors: Takashi Kubota, Kanagawa (JP); Koji Kawakita, Kanagawa (JP)

(73) Assignee: Lenovo (Singapore) Pte. Ltd., Singapore (SG)

(21) Appl. No.: 18/938,949

(22) Filed: Nov. 6, 2024

(30) Foreign Application Priority Data
Nov. 30, 2023 (JP) 2023-203152

(51) Int. Cl. G02B 13/00; G02B 9/34; H04N 23/55

(52) U.S. Cl. CPC G02B 13/008; G02B 9/34; G02B 13/004; H04N 23/55

(57) ABSTRACT

An imaging lens includes: a first lens to a fourth lens disposed in order from an object side; and an aperture stop disposed on a foremost object side. The first lens is a positive lens having a convex surface facing the object side. The second lens is a negative lens having an inflection point on at least one surface with a low thickness deviation ratio. The third lens is a positive lens having a convex surface facing an image plane side and an inflection point on a lens peripheral portion on a surface on the object side. The fourth lens is a negative lens having a concave surface on an image plane side and an inflection point on a peripheral portion.

### CROSS-REFERENCE TO RELATED APPLICATIONS

This application claims priority to Japanese Patent Application No. 2023-203152 filed on Nov. 30, 2023, the contents of which are hereby incorporated herein by reference in their entirety.

### TECHNICAL FIELD

The present disclosure relates to an imaging lens, a recognition device, and an information processing apparatus.

### DESCRIPTION OF THE RELATED ART

In recent years, there has been an increasing demand for information security in society to prevent data from leaking from information terminals. As a measure for the user, passwords are complicated to prevent information from leaking from the information terminal or to restrict the use of the information terminal. However, in information security measures in the related art, since complicating the password makes it difficult for the user to use, security by devices such as fingerprint recognition or face recognition using near-infrared rays is also strengthened simultaneously.

Furthermore, in order to establish higher recognition by motion sensing or the like, the devices for near-infrared rays are also increased in the number of pixels.

In addition, in recent years, a recognition device for recognizing a face of the user has been mounted on laptops. Therefore, the recognition device is also miniaturized in consideration of portability. The recognition device required in the market is mainly a device that achieves not only face authentication at the time of login but also a function of motion sensing or the like, and a technology has been known in which the performance of a lens of an infrared camera is improved and the number of lenses is reduced (refer to, for example, Japanese Unexamined Patent Application Publication No. 2016-018162 and Japanese Unexamined Patent Application Publication No. 2016-139093).

Incidentally, in recent years, infrared cameras capable of imaging a near-infrared band with a main wavelength of 850 nm or 940 nm, as well as those capable of imaging a monochrome (visible light) wavelength characteristic of 450 nm in addition to a near-infrared band, have been developed. Therefore, there has been a demand for an imaging lens that is smaller than infrared imaging lenses in the related art, has a wide angle of view, is bright, and has high performance while satisfying optical performance not only in the near-infrared band but also in the wavelength band of visible light.

### SUMMARY

One or more embodiments of the present disclosure provide a bright, high-performance, and small imaging lens with a wide angle of view, a recognition device, and an information processing apparatus.

According to one or more embodiments of the present disclosure, there is provided an imaging lens including a first lens to a fourth lens disposed in order from an object side; and an aperture stop disposed on a foremost object side, in which the first lens is a positive lens having a convex surface facing the object side, the second lens is a negative lens having an inflection point on at least one surface with a low thickness deviation ratio, the third lens is a positive lens having a convex surface facing an image plane side and an inflection point on a lens peripheral portion on a surface on the object side, the fourth lens is a negative lens having a concave surface on an image plane side and an inflection point on a peripheral portion, and Conditions (1) and (2) are satisfied, 0.50<|f/f1|<1.40 . . . (1) and 0.40<|f4/f1|<2.0 . . . (2), when a focal length of the first lens is denoted by f1, a focal length of the fourth lens is denoted by f4, and a focal length of an entire optical system is denoted by f.

In addition, according to one or more embodiments of the present disclosure, there is provided a recognition device including the imaging lens described above, and a solid-state imaging element configured to receive an image formed by the imaging lens and generate an imaging signal.

In addition, according to one or more embodiments of the present disclosure, there is provided an information processing apparatus including the recognition device described above, and a display unit configured to display an image corresponding to the imaging signal generated by the recognition device.

According to one or more embodiments of the present disclosure, it is possible to provide an advantageous effect of providing a bright, high-performance, and small imaging lens with a wide angle of view.

### BRIEF DESCRIPTION OF THE DRAWINGS

FIG. 1 is a diagram illustrating a lens configuration of an imaging lens according to Embodiment 1 of the present disclosure.

FIG. 2A is an aberration diagram of the imaging lens according to Embodiment 1 of the present disclosure.

FIG. 2B is an MTF of the imaging lens according to Embodiment 1 of the present disclosure.

FIG. 2C is a distortion grid of the imaging lens according to Embodiment 1 of the present disclosure.

FIG. 3 is a diagram illustrating a lens configuration of an imaging lens according to Embodiment 2 of the present disclosure.

FIG. 4A is an aberration diagram of the imaging lens according to Embodiment 2 of the present disclosure.

FIG. 4B is an MTF of the imaging lens according to Embodiment 2 of the present disclosure.

FIG. 4C is a distortion grid of the imaging lens according to Embodiment 2 of the present disclosure.

FIG. 5 is a diagram illustrating a lens configuration of an imaging lens according to Embodiment 3 of the present disclosure.

FIG. 6A is an aberration diagram of the imaging lens according to Embodiment 3 of the present disclosure.

FIG. 6B is an MTF of the imaging lens according to Embodiment 3 of the present disclosure.

FIG. 6C is a distortion grid of the imaging lens according to Embodiment 3 of the present disclosure.

FIG. 7 is a diagram illustrating a lens configuration of an imaging lens according to Embodiment 4 of the present disclosure.

FIG. 8A is an aberration diagram of the imaging lens according to Embodiment 4 of the present disclosure.

FIG. 8B is an MTF of the imaging lens according to Embodiment 4 of the present disclosure.

FIG. 8C is a distortion grid of the imaging lens according to Embodiment 4 of the present disclosure.

FIG. 9 is a diagram illustrating a lens configuration of an imaging lens according to Embodiment 5 of the present disclosure.

FIG. 10A is an aberration diagram of the imaging lens according to Embodiment 5 of the present disclosure.

FIG. 10B is an MTF of the imaging lens according to Embodiment 5 of the present disclosure.

FIG. 10C is a distortion grid of the imaging lens according to Embodiment 5 of the present disclosure.

FIG. 11 is a diagram illustrating a lens configuration of an imaging lens according to Embodiment 6 of the present disclosure.

FIG. 12A is an aberration diagram of the imaging lens according to Embodiment 6 of the present disclosure.

FIG. 12B is an MTF of the imaging lens according to Embodiment 6 of the present disclosure.

FIG. 12C is a distortion grid of the imaging lens according to Embodiment 6 of the present disclosure.

FIG. 13 illustrates the reflectivity characteristics of an example of a near-infrared region compatible coating on the lens surface of each of the first lens to fourth lenses of the imaging lenses according to Embodiments 1 to 6 of the present disclosure.

FIG. 14 is a diagram illustrating a schematic configuration of an information processing apparatus including a recognition device having an imaging lens according to each embodiment of the present disclosure.

FIG. 15 is a diagram illustrating a schematic configuration of the recognition device of FIG. 14.

FIG. 16 is a block diagram illustrating a functional configuration of the information processing apparatus including the recognition device having the imaging lens according to each embodiment of the present disclosure.

### DETAILED DESCRIPTION

Hereinafter, an imaging lens, a recognition device, and an information processing apparatus according to the present disclosure will be described with reference to the accompanying drawings. The present disclosure is not limited to the following embodiments. In addition, in the following description, each drawing referred to is merely illustrated in an outline of shape, size, and positional relationship to the extent that the contents of the present disclosure can be understood. That is, the present disclosure is not limited to the shapes, sizes, and positional relationships illustrated in each drawing. In addition, the same reference numeral is attached to the same parts, and detailed descriptions will be omitted.

### EMBODIMENTS

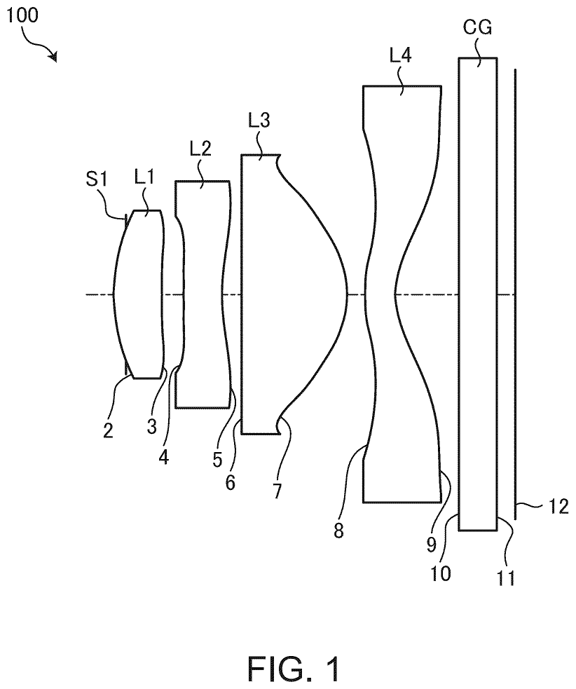

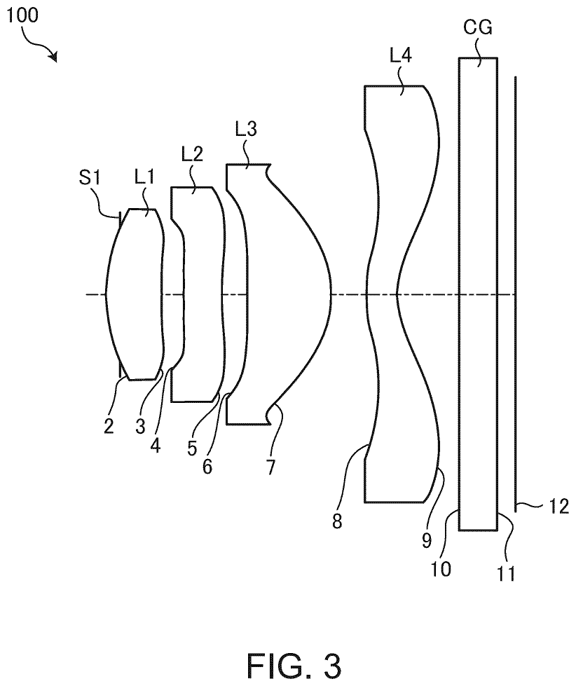

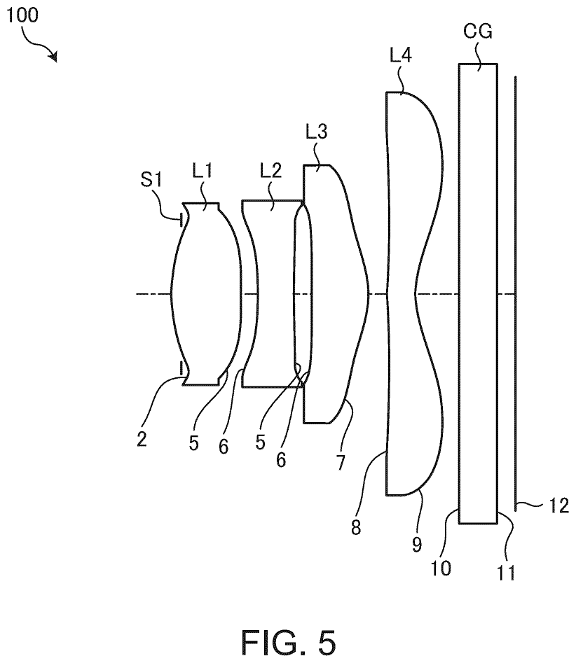

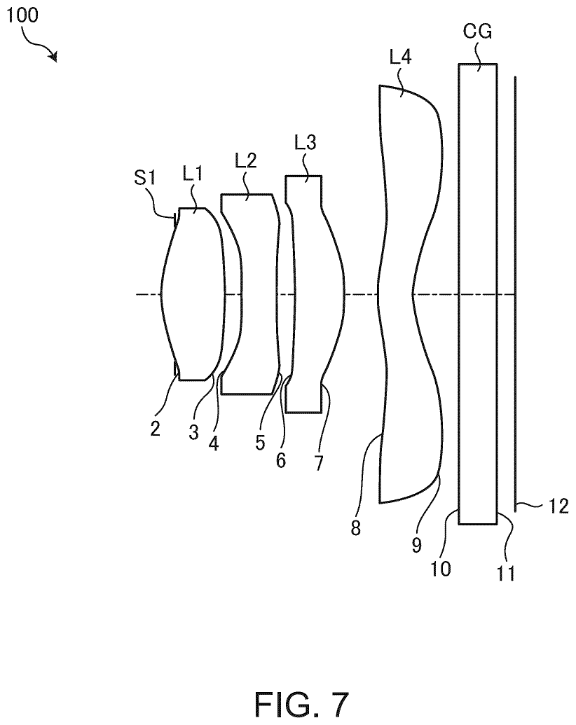

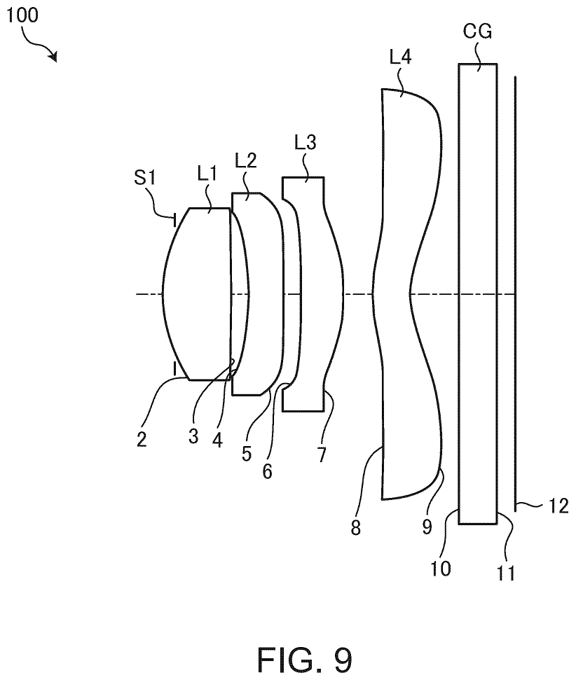

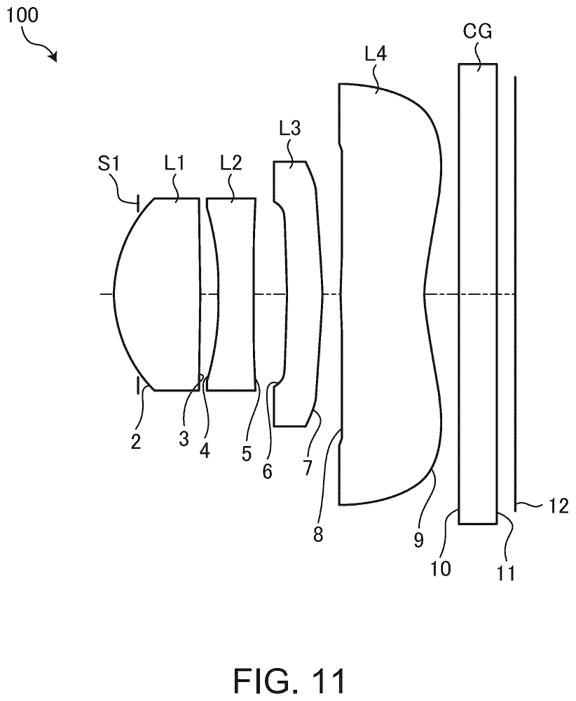

FIGS. 1, 3, 5, 7, 9, and 11 are cross-sectional views illustrating the lens configurations of the imaging lenses of Embodiments 1 to 6, respectively. In each cross-sectional view, a left is an object side (front), and a right is an image side (rear).

An imaging lens 100 according to one or more embodiments includes a first lens L1, a second lens L2, a third lens L3, and a fourth lens L4 that are disposed in order from the object side to the image side. Furthermore, the imaging lens 100 includes an aperture stop S (STOP) disposed on the object side of the first lens L1.

In FIGS. 1, 3, 5, 7, 9, and 11, reference numerals 1 to 9 attached to any of the first lens L1 to the fourth lens L4 or the aperture stop S represent the surfaces of each lens or the stop. Hereinafter, these surfaces are referred to as surface 1 to surface 9 in order from the object side to the image side. The surface 1 is the surface of the aperture stop S. Furthermore, in FIGS. 1, 3, 5, 7, 9, and 11, a reference numeral CG represents an infrared parallel flat plate equivalent to a plate having at least one or more of a cover glass of a solid-state imaging element and various filters. An incident side surface of the infrared parallel flat plate CG is referred to as a surface 10, and an image side surface is referred to as a surface 11.

In the imaging lens 100, an aperture stop, a first lens L1, a second lens L2, a third lens L3, and a fourth lens L4 are disposed sequentially from a foremost object side. The imaging lens 100 has a lens configuration in which the first lens L1 is a positive lens, the second lens L2 is a negative lens having a negative power, the third lens L3 is a positive lens, and the fourth lens L4 is a negative lens, with the positive and negative lenses arranged in order. In this configuration, spherical aberration and coma aberration can be easily corrected and good telecentricity on the image side can be realized.

The first lens L1 is a positive lens having a convex surface facing the object side, and may be a meniscus lens or a biconvex lens. As described in the examples below, the material of the first lens L1 may be either plastic or glass.

The second lens L2 is configured using a negative lens having an inflection point on at least one surface with a low thickness deviation ratio, but the inflection points may be located on both surfaces. Here, the inflection point on one surface is a region including 60% to 80% of the position from the optical axis toward the outer edge with respect to the diameter of the second lens L2 on the surface 4 side or the surface 5 side.

The third lens L3 is configured using a positive lens having a convex surface facing the image plane side and an inflection point on the lens peripheral portion of the object side surface. Here, the inflection point on the lens peripheral portion is a region including 80% to 90% of the position from the optical axis toward the outer edge with respect to the diameter of the third lens L3 on the surface 7 side.

The fourth lens L4 is configured using a negative lens having a concave surface on the image plane side and an inflection point on the peripheral portion. Here, the inflection point of the peripheral portion is a region including 60% to 80% of the position from the optical axis toward the outer edge with respect to the diameter of the fourth lens L4 on the surface 8 side.

In the first lens L1 to the fourth lens L4 configured as described above, the first lens L1 may be aspheric or spherical, but the second lens L2, the third lens L3, and the fourth lens L4 are all aspherical lenses, and each lens has the aspherical shape. Furthermore, when the second lens L2, the third lens L3, and the fourth lens L4 have shapes with inflection points, it is possible to achieve high degree of aberration corrections while reducing the thickness (total length) of the imaging lens 100 in the optical direction.

In addition, regarding the material of the lens, as illustrated in the examples, an optical plastic material or a glass material is used.

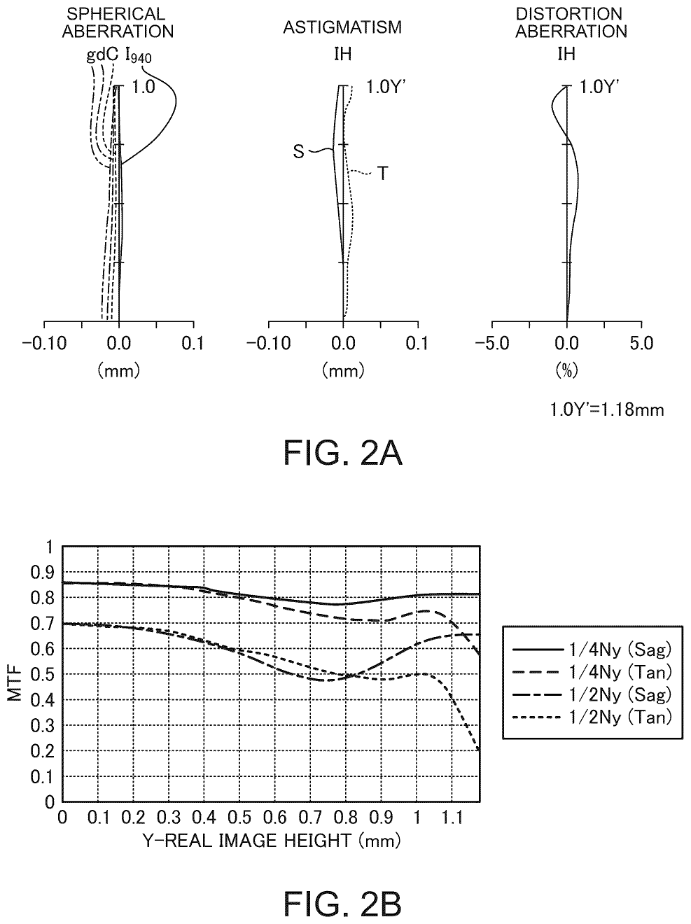

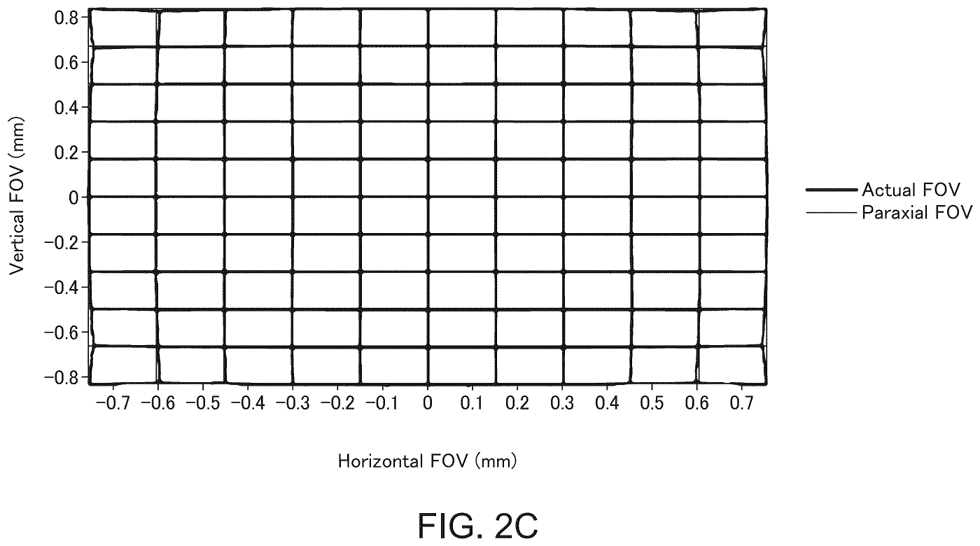

FIGS. 2A to 2C, FIGS. 4A to 4C, FIGS. 6A to 6C, FIGS. 8A to 8C, FIGS. 10A to 10C, and FIGS. 12A to 12C are vertical aberration diagrams, MTF, and distortion grids of the imaging lenses 100 of Embodiments 1 to 6, respectively. The spherical aberration diagram illustrates the amount of spherical aberration with respect to each of the d-line (yellow: wavelength of 587.6 nm), the g-line (blue: wavelength of 435.8 nm), the C-line (red: wavelength 653.3 nm), and the near-infrared rays I₉₄₀ (940 nm). In addition, in the astigmatism diagram, the solid line S illustrates the amount of astigmatism on the sagittal image plane, and the broken line T illustrates the amount of astigmatism on the tangential image plane. Furthermore, the distortion aberration diagram illustrates the amount of distortion aberration only for the d-line. In addition, Angle (deg) illustrates the imaging half angle of view (°). In addition, in the MTF, the frequency is ¼Ny and ½Ny. A five-point chain line illustrates the MTF of the sagittal image plane, and a rough broken line illustrates the MTF of the tangential image plane at ¼Ny. A three-point chain line illustrates the MTF of the sagittal image plane, and a fine broken line illustrates the MTF of the tangential image plane at ½Ny. In addition, regarding the distortion grid, a thin line illustrates a paraxial FOV (ideal) grid and a thick line illustrates an actual FOV grid.

Next, the conditions of the imaging lens 100 according to one or more embodiments will be described.

The imaging lens 100 according to one or more embodiments satisfies following Conditions (1) and (2) when the focal length of the first lens L1 is denoted by f1, the focal length of the fourth lens L4 is denoted by f4, and the focal length of the entire optical system is denoted by f.

$$0.5 < \vert f / f 1 \vert < 1.4 \qquad ( 1 )$$

$$0.4 < \vert f 4 / f 1 \vert < 2. \qquad ( 2 )$$

Condition (1) is a conditional expression related to the entire focal length of the imaging lens 100 and the lens power of the first lens L1.

In a case where f/f1 is equal to or less than the lower limit of Condition (1), the entire focal length tends to be short, which is advantageous for achieving a wide angle. However, the astigmatism tends to be excessive, and the distortion aberration also tends to increase, making it difficult to realize the desired performance. In addition, in a case where f/f1 is equal to or greater than the upper limit of Condition (1), although the spherical aberration and the astigmatism tend to be improved, the angle of view tends to be narrowed, making it undesirable as the desired performance in the present invention cannot be achieved. Therefore, the imaging lens 100 can realize a balance between shortening (reduction in height) and high performance by satisfying Condition (1).

Condition (2) is a conditional expression related to the positive power of the first lens L1 and the negative power of the fourth lens L4.

In a case where |f4/f1| is equal to or less than the lower limit of Condition (2), the astigmatism tends to be excessive, and the spherical aberration is also generated to a large extent, making it difficult to realize the desired performance. In addition, in a case where |f4/f1| is equal to or greater than the upper limit of Condition (2), the spherical aberration tends to be under-corrected, so that the balance with the astigmatism is lost, and it is difficult to realize the desired performance.

That is, when the imaging lens 100 satisfies Condition (1) and Condition (2), a balance between the spherical aberration and the astigmatism is achieved and the bright, high-performance, and small (compact) imaging lens 100 can be realized. Here, the small size means reducing the thickness by shortening the total length of the imaging lens 100 in the optical axis direction and reducing the diameter of the imaging lens 100.

In addition, in the imaging lens 100 according to one or more embodiments, Condition (3) is satisfied, when the refractive index of the material of the first lens L1 with respect to the d-line is denoted by N1 and the refractive index of the material of the fourth lens L4 with respect to the d-line is denoted by N4.

$$N 1 < N 4 \qquad ( 3 )$$

Condition (3) defines the relationship between the refractive index N1 of the material of the first lens L1 and the refractive index N4 of the material of the fourth lens L4.

The first lens L1 is a positive lens, and the fourth lens L4 is a negative lens. In one or more embodiments of the present disclosure, in order to appropriately correct chromatic aberration and balance miniaturization, the refractive index N1 of the first lens L1 is formed with a material with a refractive index smaller than the refractive index N4 of the fourth lens L4, and the desired good chromatic aberration can be realized by satisfying Condition (3).

In addition, in the imaging lens 100 according to one or more embodiments, Condition (4) is satisfied, when the refractive index of the material of the first lens L1 with respect to the d-line is denoted by N1.

$$1.49 < N 1 < 1.55 \qquad ( 4 )$$

In a case where the refractive index N1 is equal to or less than the lower limit of Condition (4), the optical performance is further improved, but the cost is increased, which is not preferable. In addition, in a case where the refractive index N1 is equal to or greater than the upper limit of Condition (4), the optical performance is not preferable because chromatic aberration is affected. Therefore, when the imaging lens 100 satisfies Condition (4), a balance between cost and chromatic aberration is achieved, and the bright, high-performance, and small (compact) imaging lens 100 can be realized.

In addition, in the imaging lens 100 according to one or more embodiments, Condition (5) is satisfied, when the refractive index of the material of the fourth lens L4 with respect to the d-line is denoted by N4.

$$1.63 < N 4 < 1.67 \qquad ( 5 )$$

In a case where the refractive index N4 is equal to or less than the lower limit of Condition (5) or in a case where the refractive index N4 is equal to or greater than the upper limit of Condition (5), the balance with the chromatic aberration is lost. In consideration of the balance between cost and chromatic aberration, when Condition (5) is satisfied, the bright, high-performance, and small imaging lens 100 can be realized.

In addition, the imaging lens 100 according to one or more embodiments satisfies Condition (6) when the focal length of the entire optical system (imaging lens 100) is denoted by f and the total length of the optical system (imaging lens 100 in the longitudinal direction) is denoted by OAL.

$$0.6 < f / OAL < 0.9 \qquad ( 6 )$$

Condition (6) is a condition that balances the focal length f of the entire optical system and the total length OAL.

In the imaging lens 100 according to one or more embodiments, in a case where f/OAL is equal to or less than the lower limit of Condition (6), a further wide angle can be realized, but the diameter of the front lens tends to increase, which may lead to an increase in size. In addition, in a case where f/OAL is equal to or greater than the upper limit of Condition (6), the total length of the optical system is reduced, but it is difficult to achieve a wide angle of view. The imaging lens 100 satisfying Condition (6) can realize miniaturization in size and a wide angle.

In addition, in the imaging lens 100 according to one or more embodiments, Condition (7) is satisfied, when the total length of the optical system is denoted by OAL and the optical effective diameter of the lens (first lens L1) disposed on the foremost object side is denoted by EfD1.

$$2.2 < OAL / EfD 1 < 3.2 \qquad ( 7 )$$

Condition (7) is a condition that balances the total length of the lens and the diameter of the front lens of the lens (first lens L1).

In a case where OAL/EfD1 is equal to or less than the lower limit of Condition (7), the optical system is miniaturized (shortened in the optical axis direction), but it is difficult to achieve a wide angle of view. In a case where OAL/EfD1 is equal to or greater than the upper limit of Condition (7), the performance of the optical system is improved, but it is difficult to achieve miniaturization (shortening in the optical axis direction). The imaging lens 100 can realize miniaturization (shortening in the optical axis direction) and high performance by satisfying Condition (7).

In addition, in the imaging lens according to one or more embodiments, Condition (8) is satisfied, when the position of the exit pupil is denoted by EXP and the image height is denoted by IH.

$$- 1.3 < EXP / IH < - 0.9 \qquad ( 8 )$$

Condition (8) is a condition for optimizing the incidence angle of light rays on the image plane.

In a case where EXP/IH is equal to or less than the lower limit of Condition (8), the incidence angle of light rays tends to decrease, but it becomes difficult to reduce the total length of the optical system and miniaturize the optical system. In addition, in a case where EXP/IH is equal to or greater than the upper limit of Condition (8), the incidence angle of light rays tends to increase. Therefore, the imaging lens 100 can realize miniaturization by satisfying Condition (8).

In addition, in the imaging lens according to one or more embodiments, Condition (9) is satisfied, when the focal length of the first lens L1 is denoted by f1 and the focal length of the second lens L2 is denoted by f2.

$$0.4 < \vert f 1 / f 2 \vert < 0.71 \qquad ( 9 )$$

Condition (9) is a condition related to the balance of the focal lengths of the first lens L1 and the second lens L2.

In a case where |f1/f2| is equal to or less than the lower limit of Condition (9), the lens power of f2 with respect to f1 is weakened, and thus the spherical aberration and the distortion aberration are likely to be insufficient for aberration correction, making it difficult to achieve high performance. In addition, in a case where |f1/f2| is equal to or greater than the upper limit of Condition (9), the astigmatism tends to increase, which is undesirable. Therefore, the imaging lens 100 can realize high performance by satisfying Condition (9).

In addition, in the imaging lens 100 according to one or more embodiments, Condition (10) is satisfied, when the focal length of the first lens L1 is denoted by f1 and the focal length of the third lens L3 is denoted by f3.

$$0.3 < f 3 / f 1 < 2.8 \qquad ( 10 )$$

Condition (10) is a conditional expression related to the positive power of the first lens L1 and the positive power of the third lens L3.

In a case where f3/f1 is equal to or less than the lower limit of Condition (10), the astigmatism tends to be excessive, and the distortion aberration and the coma aberration also occur significantly, making it difficult to realize the desired performance. In addition, in a case where f3/f1 is equal to or greater than the upper limit of Condition (10), the spherical aberration tends to be under-corrected, so that the balance with the astigmatism is lost, and it is difficult to realize the desired performance.

In addition, in the imaging lens 100 according to one or more embodiments, Condition (11) is satisfied, when the focal length of the third lens L3 is denoted by f3 and the focal length of the fourth lens L4 is denoted by f4.

$$0.5 < \vert f 3 / f 4 \vert < 2. \qquad ( 11 )$$

Condition (11) is a conditional expression related to the lens power of the third lens L3 and the lens power of the fourth lens L4.

In a case where f3/f4 is equal to or less than the lower limit of Condition (11), the astigmatism tends to be excessive, and the distortion aberration also tends to increase, making it difficult to realize the desired performance. In addition, in a case where f3/f4 is equal to or greater than the upper limit of Condition (11), the entire focal length is increased and the angle of view tends to be narrowed, so that the astigmatism and the distortion aberration tend to be improved, but the spherical aberration tends to increase, making it difficult to realize the desired performance. Therefore, the imaging lens 100 can realize a balance between shortening (reduction in height) and high performance by satisfying Condition (11).

In addition, in the imaging lens 100 according to one or more embodiments, each of the first lens L1 to the fourth lens L4 has a near-infrared region compatible coating (laminate coating) corresponding to near-infrared rays applied onto the lens surface. The near-infrared region compatible coating corresponding to near-infrared rays transmits light in a band of 450 to 940 nm and has reflectivity of 2% or less in a band of at least the near-infrared region of 850 nm to 940 nm.

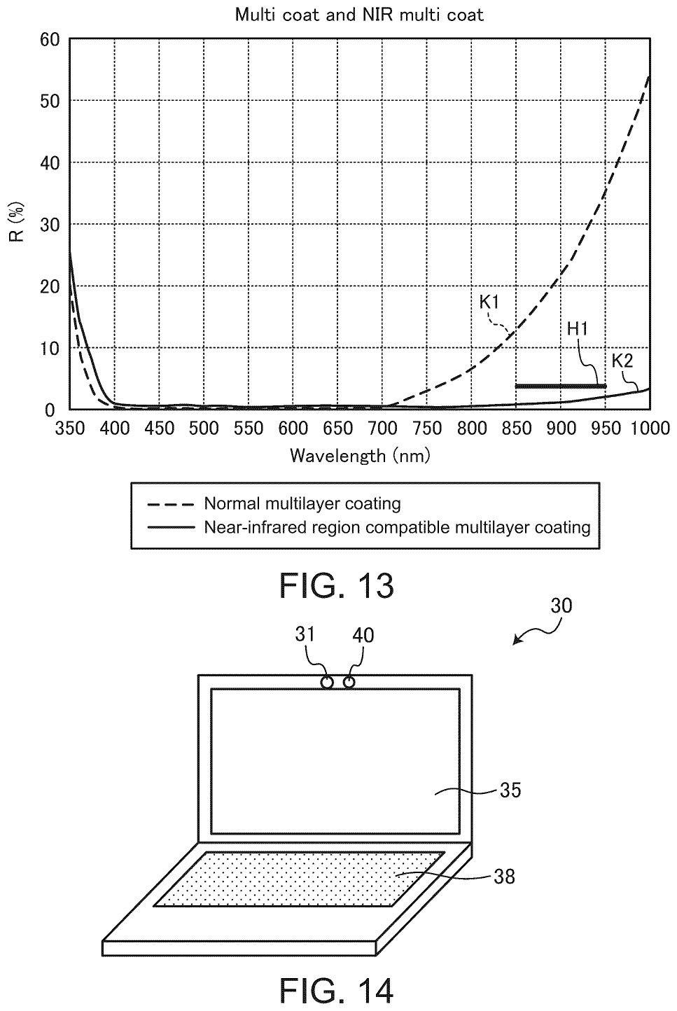

FIG. 13 illustrates the reflectivity characteristics of an example of the near-infrared region compatible coating applied to at least one surface or more on the lens surface of each of the first lens L1 to the fourth lens L4 of the imaging lens 100 according to Embodiments 1 to 6. In FIG. 13, the horizontal axis indicates the wavelength band, and the vertical axis indicates the reflectivity. In FIG. 13, curve K1 illustrates the reflectivity characteristics of a normal multilayer coating, and curve K2 illustrates the reflectivity characteristics of the near-infrared region compatible coating (near-infrared region compatible multilayer coating).

On each of the lens surfaces of the first lens L1 to the fourth lens L4 of the imaging lens 100, the near-infrared region compatible coating (solid line) having the reflectivity characteristics illustrated by curve K1 in FIG. 13 is applied (coated or laminated) onto the lens. When such a near-infrared region compatible coating is applied (coated or laminated) onto the lens, it is possible to realize an imaging lens corresponding to near-infrared rays and an imaging device including the imaging lens. The near-infrared region compatible coating is applied by being attached to each of the lens surfaces of the first lens L1 to the fourth lens L4 using a well-known technology. As a matter of course, a sheet of the near-infrared region compatible coating may be attached to each of the lens surfaces of the first lens L1 to the fourth lens L4.

The imaging lens 100 according to one or more embodiments of the present disclosure includes four lenses, and the number of surfaces of the lens is eight. The transmittance of the imaging lens 100 is also an important element as an imaging device and a recognition device.

Here, when the transmittance of the imaging lens 100 having four lenses in Embodiments 1 to 6 of the present disclosure at near-infrared rays of 940 nm is simply calculated, in the case of the four lenses configuration, the transmittance is the eighth power of (1−reflectivity) because there are eight reflecting surfaces. Therefore, in a case where the normal multilayer coating (dotted line) illustrated by the curve K1 in FIG. 13 is applied (coated), the transmittance at 940 nm is the transmittance at 940 nm=(1−0.33)\hat{ }8=4.1% when the reflectivity at 940 nm is 33%, which is not preferable.

On the other hand, as illustrated by the curve K2 of FIG. 13, in a case of being calculated in the same manner, when reflectivity at 940 nm (refer to straight line H1) is 2%, the transmittance the near-infrared region compatible multilayer coating (curve K2) at 940 nm is the transmittance at 940 nm=(1−0.02)\hat{ }8=85.1%, it is possible to realize a good transmittance, and is suitable as the imaging lens 100 for the imaging device capable of imaging near-infrared rays.

Therefore, in the imaging lens 100 of each of Embodiments 1 to 6, the near-infrared region compatible multilayer coating corresponding to near-infrared rays is applied onto the lens surface of each of the first lens L1 to the fourth lens L4, light in the band of 450 to 940 nm is transmitted, and reflectivity in the band of at least the near-infrared region of 850 nm to 940 nm is 2% or less. As illustrated by the curve K2 in FIG. 13, in the near-infrared region compatible multilayer coating, although the reflectivity is low in the visible light region in the band of 450 to 650 nm, in consideration of the sensor characteristics (image sensor characteristics) of a near-infrared imaging device, the visible light region may have reflectivity of 2% or more.

In addition, the cover glasses described in each of Embodiments 1 to 6 are also applied (coated) with an infrared-compatible multi-coating having reflectivity of 2% or less in a band of approximately 850 to 940 nm as illustrated in FIG. 13 and correspond to the near-infrared imaging device.

### [Recognition Device]

Next, an embodiment of an information processing apparatus (PC) including a recognition device that uses the imaging lens 100 according to one or more embodiments as an imaging optical system will be described.

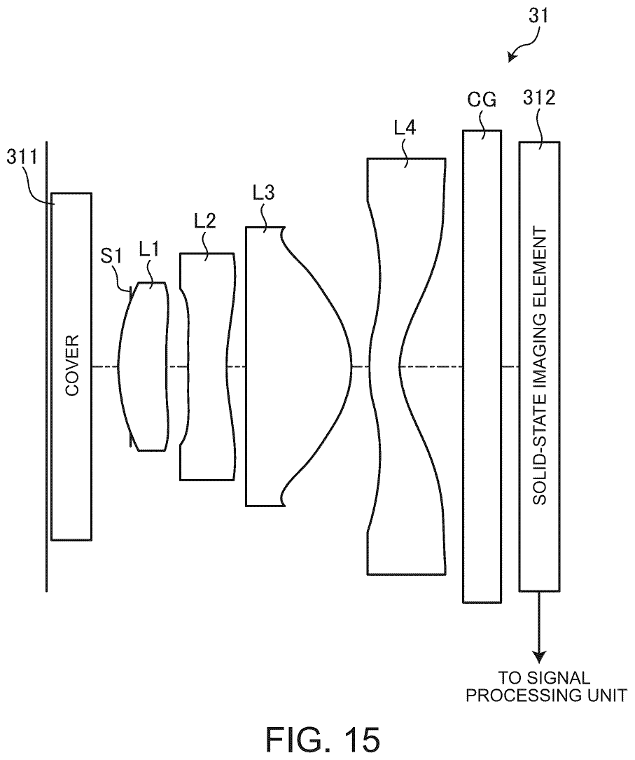

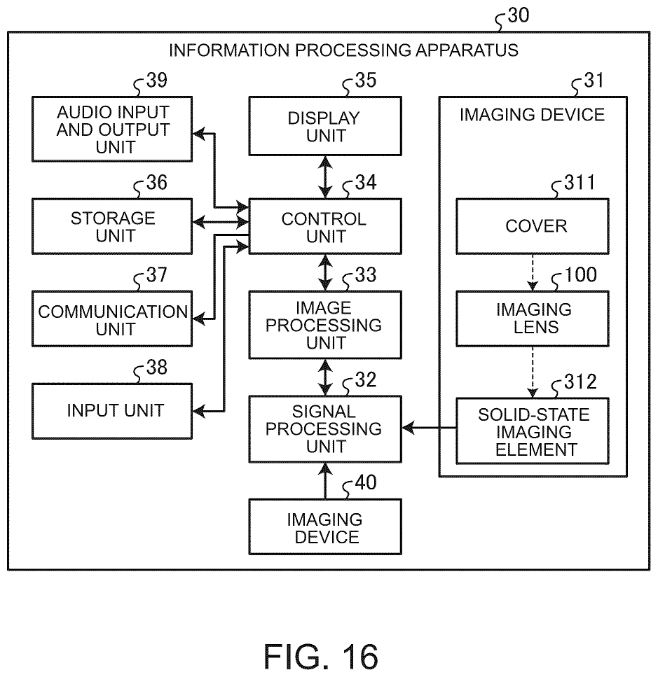

FIG. 14 is a diagram illustrating a schematic configuration of an information processing apparatus including a recognition device having the imaging lens 100 according to one or more embodiments. FIG. 15 is a diagram illustrating a schematic configuration of the recognition device of FIG. 14. FIG. 16 is a block diagram illustrating the functional configuration of the information processing apparatus including the recognition device having the imaging lens according to one or more embodiments.

An information processing apparatus 30 illustrated in FIGS. 14 to 16 includes at least a recognition device 31, a signal processing unit 32, an image processing unit 33, a control unit 34, a display unit 35, a storage unit 36, a communication unit 37, an input unit 38, an audio input and output unit 39, and an imaging device 40.

The recognition device 31 generates an imaging signal by capturing a predetermined visual field region under the control of the control unit 34 and outputs the imaging signal to the signal processing unit 32. As illustrated in FIG. 15, the recognition device 31 includes at least a cover 311, the imaging lens 100 according to one or more embodiments, and a solid-state imaging element 312. The recognition device 31 is disposed on the front surface side of the information processing apparatus 30. Specifically, the recognition device 31 is disposed in a position parallel to the imaging device 40.

The cover 311 is configured using a cover glass or the like, which serves as a member for protecting the imaging lens 100 from dirt and dust.

The solid-state imaging element 312 receives an image of an imaging target object formed by the imaging lens 100 and performs photoelectric conversion to generate an imaging signal. The solid-state imaging element 312 is configured using a CCD sensor, a CMOS sensor, or the like. The solid-state imaging element 312 preferably has 300,000 pixels or more, so-called VGA or more (640×480 or more) effective pixels disposed in a two-dimensional matrix.

The signal processing unit 32, under the control of the control unit 34, performs A/D conversion processing or the like on the imaging signal input from the solid-state imaging element 312 to convert the imaging signal into a digital imaging signal, and outputs the digital imaging signal to the image processing unit 33. The signal processing unit 32 is configured using, for example, a digital signal processor (DSP) or the like. In addition, the signal processing unit 32, under the control of the control unit 34, performs A/D conversion processing or the like on the imaging signal input from the imaging device 40 to convert the imaging signal into a digital imaging signal, and outputs the digital imaging signal to the image processing unit 33.

The image processing unit 33, under the control of the control unit 34, performs predetermined image processing on the digital imaging signal input from the signal processing unit 32 and outputs the processed signal to the display unit 35 or the storage unit 36. The image processing unit 33 is configured using, for example, a graphics processing unit (GPU) or the like.

The control unit 34 controls each component that constitutes the information processing apparatus 30. The control unit 34 includes a processor and a memory. The processor is configured using a CPU, a field-programmable gate array (FPGA), or the like. The memory is configured using a random access memory (RAN), a read-only memory (ROM), or the like.

The display unit 35, under the control of the control unit 34, displays a video during imaging on which the image processing unit 33 performs image processing, a captured image, a still image corresponding to the image signal stored in the storage unit 36, and various types of information on the information processing apparatus 30.

The storage unit 36 stores various types of information on the information processing apparatus 30, programs executed by the information processing apparatus 30, and imaging signals (RAW data or JPEG data) captured by the imaging device 40. The storage unit 36 is configured using a flash memory, a solid state drive (SSD), a hard disk drive (HDD), a memory card, and the like.

The communication unit 37, under the control of the control unit 34, transmits the imaging signal captured by the imaging device 40 to the outside via the network in accordance with a predetermined communication standard and receives various types of information input from the outside. For example, the communication unit 37 uses the communication standard conforming to 4G, LTE, 5G, WiMAX, Wi-Fi (registered trademark), or the like, established by 3GPP (registered trademark) and IEEE.

The input unit 38 receives an operation input by the user and outputs operation information corresponding to the received operation to the control unit 34. The input unit 38 is configured using, for example, a touch panel, a keyboard, a mouse, or the like.

The audio input and output unit 39, under the control of the control unit 34, receives the input of ambient sound, converts the ambient sound into an audio signal, and outputs the audio signal to the storage unit 36 or the communication unit 37. In addition, the audio input and output unit 39, under the control of the control unit 34, converts the audio signal input from the storage unit 36 or the communication unit 37 and outputs the converted audio signal to the outside. The audio input and output unit 39 is configured using a microphone, a speaker, or the like.

The imaging device 40 generates an imaging signal by capturing a predetermined visual field region under the control of the control unit 34 and outputs the imaging signal to the signal processing unit 32. The imaging device 40 is disposed on the front surface side of the information processing apparatus 30. Specifically, the imaging device 40 is disposed at a position where the user of the information processing apparatus 30 can be imaged. As a matter of course, the disposition position of the imaging device 40 can be appropriately changed according to the shape, size, and usage aspect of the information processing apparatus 30.

In the information processing apparatus 30 configured as described above, it is possible to perform face recognition or the like with an external device at a high image quality of 300,000 pixels or more using the recognition device 31 including the imaging lens 100, and it is possible to perform communication through Web communication via the network.

In one or more embodiments, although the PC has been described as an example of the information processing apparatus 30, the recognition device 31 can be applied to, for example, the imaging device such as a tablet-type terminal and a mobile phone. As a matter of course, the recognition device 31 may be applied to a Web camera or the like that can communicate with a PC or the like through wired or wireless communication.

According to the embodiments described above, it is possible to realize a bright, high-performance, and small device with a wide angle of view.

In addition, according to one or more embodiments, the half angle of view of approximately 38.5° can be realized with four lenses.

In addition, according to one or more embodiments, since the imaging lens 100 can realize a device having a wide angle of view, a small F-number, high performance, and small size, it is possible to cope with imaging in various environments, such as dark environments, and high-speed imaging in the case of video recording.

In addition, according to one or more embodiments, since it is possible to realize a bright, high-performance, and small device with a wide angle of view, it is possible to improve the matching between the angle of incidence on a light receiving element of the solid-state imaging element and the light rays incident on the light receiving surface on the image side.

In addition, according to one or more embodiments, since the bright, high-performance, and small half angle of view of approximately 38.5° can be configured with four lenses, the four lenses can be used as a single focal length lens used in mobile phones such as smartphones or PCs. Therefore, in a case where video recording with a high pixel of VGA or more (640×480 or more) is required, sufficient aberration correction can be performed compared to the imaging lens in the related art, and the required performance can be met.

In addition, according to one or more embodiments, since the bright, high-performance, and small half angle of view of approximately 38.5° can be configured with four lenses, the total length of the imaging lens 100 in the optical axis direction can be shortened, the lens diameter can be reduced, and miniaturization can be realized. Therefore, the refractive power of the miniaturized lens is reduced, and the effect of manufacturing error and assembly error can be reduced. As a result, productivity is improved, and production costs can be reduced.

A plurality of components disclosed in the information processing apparatus according to one or more embodiments of the present disclosure can be combined as appropriate to form various inventions. For example, some components may be deleted from all the components described in the information processing apparatus according to one or more embodiments of the present disclosure. Furthermore, the components described in the information processing apparatus according to one or more embodiments of the present disclosure may be combined as appropriate.

In addition, in the information processing apparatus according to one or more embodiments of the present disclosure, the “unit” described above can be interpreted as “means,” “circuit,” and the like. For example, the control unit can be interpreted as control means or a control circuit.

In addition, the program executed by the information processing apparatus according to one or more embodiments of the present disclosure is recorded and provided on a recording medium such as a CD-ROM, a flexible disk (FD), a CD-R, a digital versatile disk (DVD), a USB medium, or a flash memory or the like, which can be read by a computer, with file data of an installable format or an executable format.

In addition, the program executed by the information processing apparatus according to one or more embodiments of the present disclosure may be stored on a computer connected to a network such as the Internet or the like and provided by being downloaded via the network.

### EXAMPLES

Hereinafter, Examples 1 to 8 of the imaging lens 100 corresponding to each of Embodiments 1 to 6 will be illustrated.

The meanings of the symbols in each example are as follows.
f: focal length of the entire lens system
fl: focal length of each lens
FNo.: the number of apertures (F number)
R: radius of curvature of the surface
D: interfacial distance
Nd: refractive index for d-line
Vd: Abbe number for d-line
SD: effective radius

The aspherical surface is represented by a well-known expression (15) using an aspherical coefficient in a case where a depth in an optical axis direction is represented by X, a height from the optical axis is denoted by H, a paraxial curvature radius is denoted by R, a conical constant is denoted by k, and a high-order aspherical coefficient is denoted by CN (N is an even number of 4 or more).

$$m = ( {H}^{2} / R ) / [ 1 + {\{ 1 - {k ( H / r )}^{2} \}}^{1 / 2} ] + {\sum }_{N = 4 : even} C N {H}^{N} \qquad ( 15 )$$

Here, Σ_{N≥4: even} represents a sum for even numbers of N of 4 or more.

### Example 1

f=1.4 mm, FNo.=2.0, HFOV=40⁰

Table 1 illustrates the data from Example 1.

TABLE 1

| Nc | R | D | Nd | Vd | SD | fl |
|---|---|---|---|---|---|---|
| 1 | — | −0.07 | | | 0.35 | |
| 2 | 0.898 | 0.263 | 1.5365 | 55.98 | 0.35 | 2.7 |
| 3 | 2.149 | 0.117 | | | 0.40 | |
| 4 | 2.067 | 0.213 | 1.6328 | 23.29 | 0.41 | −5.4 |
| 5 | 1.218 | 0.109 | | | 0.54 | |
| 6 | −20.672 | 0.571 | 1.5365 | 55.98 | 0.58 | 0.9 |
| 7 | −0.445 | 0.100 | | | 0.66 | |
| 8 | 0.724 | 0.165 | 1.6328 | 23.29 | 0.87 | −1.2 |
| 9 | 0.331 | 0.342 | | | 0.99 | |
| 10 | — | 0.21 | 1.516798 | 64.20 | 0.99 | — |
| 11 | — | 0.1 | | | 1.06 | |
| 12 | — | — | | | | |

The aspherical data is illustrated below.

TABLE 2

| | 2 | 3 | 4 | 5 |
|---|---|---|---|---|
| Conic | 1.1139.E+00 | 4.6527.E−01 | 4.8390.E−01 | 8.2088.E−01 |
| constant (k) | | | | |
| 4th order | 8.9778.E−01 | 2.1493.E+00 | 2.0665.E+00 | 1.2182.E+00 |
| coefficients | | | | |
| 6th order | −6.3212.E−01 | −2.4406.E+01 | −5.2134.E+01 | −5.9078.E+00 |
| coefficients | | | | |
| 8th order | 1.0286.E−01 | −6.0067.E−01 | −1.3861.E+00 | −5.6253.E−01 |
| coefficients | | | | |
| 10th order | −4.6284.E−01 | −2.3128.E−01 | −4.0377.E+00 | −7.3504.E−01 |
| coefficients | | | | |
| 12th order | 5.4658.E+00 | −1.2392.E+01 | −9.7196.E+00 | 6.0065.E−01 |
| coefficients | | | | |
| 14th order | −3.3002.E+01 | −1.4642.E+01 | −1.3124.E+01 | 3.0270.E+00 |
| coefficients | | | | |
| 16th order | 3.6680.E−01 | −1.6132.E+00 | 3.2147.E+01 | 1.6850.E+00 |
| coefficients | | | | |
| 18th order | −1.7965.E−03 | −3.8351.E+00 | 2.1352.E+02 | −7.5170.E+00 |
| coefficients | | | | |
| 20th order | 0.0000.E+00 | 0.0000.E+00 | 0.0000.E+00 | 0.0000.E+00 |
| coefficients | | | | |
| | 6 | 7 | 8 | 9 |
| Conic | −4.8374.E−02 | −2.2454.E+00 | 1.3810.E+00 | 3.0241.E+00 |
| constant (k) | | | | |
| 4th order | −2.0672.E+01 | −4.4535.E−01 | 7.2413.E−01 | 3.3067.E−01 |
| coefficients | | | | |
| 6th order | −2.5000.E+02 | −2.5212.E+00 | −1.4903.E+01 | −3.9845.E+00 |
| coefficients | | | | |
| 8th order | 1.0477.E−01 | −5.1603.E−01 | −5.4241.E−01 | −5.0702.E−01 |
| coefficients | | | | |
| 10th order | −3.0735.E−01 | −1.0322.E−01 | −8.1949.E−02 | 4.5889.E−01 |
| coefficients | | | | |
| 12th order | −8.4823.E−02 | 4.0644.E−02 | 4.2037.E−01 | −2.2679.E−01 |
| coefficients | | | | |
| 14th order | 1.0332.E−01 | 2.6389.E−01 | 8.5624.E−02 | −7.4036.E−02 |
| coefficients | | | | |
| 16th order | 1.9349.E−01 | 2.1637.E+00 | 8.9673.E−02 | 6.6208.E−02 |
| coefficients | | | | |
| 18th order | 8.3682.E−02 | 8.6804.E+00 | −1.7319.E−01 | 4.4145.E−02 |
| coefficients | | | | |
| 20th order | 0.0000.E+00 | 0.0000.E+00 | 0.0000.E+00 | 0.0000.E+00 |
| coefficients | | | | |

In the notation of the aspherical surface, for example, “2.1143·E−02” means “2.1143*10−2”. The same applies to the other examples below.

The values of the parameters of each condition are as follows. Table 3 also describes the EP: incident pupil position.

TABLE 3

| Item | Number |
|---|---|
| f | 1.40 |
| Fno | 2.00 |
| OAL | 2.12 |
| IH | 1.18 |
| EfD1 | 0.70 |
| Half FOV | 40.15 |
| EP | 0.00 |
| EXP | −1.46 |
| f12 | 2.72 |
| f3 | −5.37 |
| f4 | 0.85 |
| f5 | −1.19 |
| N1 | 1.5365 |
| N2 | 1.6328 |
| N3 | 1.5365 |
| N4 | 1.6328 |

In addition to Conditional Expressions (1) to (11), (12) to (14) are also described as references in the table.

TABLE 4

| | Conditional | | | |
|---|---|---|---|---|
| | expression | Number | Lower limit | Upper limit |
| (1) | f/f1 | 0.512 | 0.5 | 1.4 |
| (2) | \|f4/f1\| | 0.435 | 0.4 | 2.0 |
| (3) | N1 < N4 | Refer to | | |
| | | Table 3 | | |
| (4) | N1 | 1.536 | 1.49 | 1.55 |
| (5) | N4 | 1.633 | 1.63 | 1.67 |
| (6) | f/OAL | 0.658 | 0.6 | 0.9 |
| (7) | OAL/EfD1 | 3.038 | 2.2 | 3.2 |
| (8) | EXP/IH | −1.237 | −1.3 | −0.9 |
| (9) | \|f1/f2\| | 0.507 | 0.40 | 0.71 |
| (10) | f3/f1 | 0.314 | 0.30 | 2.80 |
| (11) | \|f3/f4\| | 0.721 | 0.5 | 2.0 |
| (12) | \|f4/f2\| | 0.221 | 0.20 | 1.30 |
| (13) | \|f3/f2\| | 0.159 | 0.10 | 1.50 |
| (14) | OAL/2*IH | 0.898 | 0.70 | 1.00 |

The meanings of Conditional Expressions (12) to (14) are as follows.

$$0.2 < \vert f 4 / f 2 \vert < 1.3 \qquad ( 12 )$$

Regarding Conditional Expression (12), f2 represents the focal length of the second lens L2, and f4 represents the focal length of the fourth lens L4, and it is a condition for the balance of the focal lengths of the second lens L2 and the fourth lens L4. It is possible to achieve high performance within the range of Conditional Expression (12). In a case where the value is equal to or less than the lower limit of the conditional expression, the astigmatism increases, and in a case where the value is equal to or greater than the upper limit of Conditional Expression (12), the spherical aberration increases, and thus it is desirable to satisfy the range of the conditional expression.

$$0.1 < \vert f 3 / f 2 \vert < 1.5 \qquad ( 13 )$$

Regarding Conditional Expression (13), f2 represents the focal length of the second lens L2, and f3 represents the focal length of the third lens L3, and it is a condition for the balance of the focal lengths of the second lens L2 and the third lens L3. It is possible to achieve high performance within the range of Conditional Expression (13). In a case where the value is equal to or less than the lower limit of the conditional expression, the astigmatism increases, and in a case where the value is equal to or greater than the upper limit of Conditional Expression (12), the spherical aberration increases, and thus it is preferable to satisfy the range of the conditional expression.

In the present invention, although the power of the second lens L2 is weak compared to the power of the other lenses, in the present invention, by disposing a positive or negative lens having a relatively weak power compared to other lenses as the second lens, it is possible to effectively correct the astigmatism, the spherical aberration, and the distortion aberration.

$$0.7 < ORL / 2 * IH < 1. \qquad ( 14 )$$

Regarding Conditional Expression (14), OAL illustrates the optical overall length, IH illustrates the image height, the so-called image circle of the optical system, and it illustrates the ratio of the optical overall length to the image circle. As illustrated in Conditional Expression (14), the optical overall length with respect to the image circle is 0.7 to 1.0, and it is clear that the imaging lens according to the present invention has a low height.

In addition, these conditional expressions are also applied to Example 2 and subsequent examples.

In addition, in each example, aspherical surfaces are used from the first lens L1 to the fourth lens L4, and aberrations are effectively corrected by the aspherical surfaces.

The aberration diagram, the MTF, and the distortion grid related to Example 1 are illustrated in FIGS. 2A to 2C, and as is clear from each drawing, the performance is good.

### Example 2

f=1.5 mm, FNo.=2.0, HFOV=38.5⁰

Table 5 illustrates the data from Example 2.

TABLE 5

| No | R | D | Nd | Vd | SD | fl |
|---|---|---|---|---|---|---|
| 1 | — | −0.07 | | | 0.37 | |
| 2 | 0.902 | 0.298 | 1.5350 | 55.71 | 0.37 | 2.4 |
| 3 | 2.898 | 0.116 | | | 0.42 | |
| 4 | 3.392 | 0.200 | 1.6652 | 29.43 | 0.43 | −5.5 |
| 5 | 1.684 | 0.145 | | | 0.52 | |
| 6 | −3.213 | 0.445 | 1.5350 | 55.71 | 0.54 | 1.2 |
| 7 | −0.539 | 0.192 | | | 0.64 | |
| 8 | 0.644 | 0.165 | 1.6652 | 29.43 | 0.87 | −1.7 |
| 9 | 0.367 | 0.320 | | | 1.01 | |
| 10 | — | 0.21 | 1.516798 | 64.20 | 1.03 | — |
| 11 | — | 0.1 | | | 1.09 | |
| 12 | — | — | | | | |

The aspherical data is illustrated below.

TABLE 6

| | 2 | 3 | 4 | 5 |
|---|---|---|---|---|
| Conic | 1.1082.E+00 | 3.4504.E−01 | 2.9482.E−01 | 5.9373.E−01 |
| constant(k) | | | | |
| 4th order | 9.0237.E−01 | 2.8982.E+00 | 3.3919.E+00 | 1.6843.E+00 |
| coefficients | | | | |
| 6th order | −5.9280.E−01 | −3.5661.E+01 | −1.3217.E+02 | −2.8676.E+00 |
| coefficients | | | | |
| 8th order | 9.2822.E−02 | −8.0115.E−01 | −1.7965.E+00 | −9.3984.E−01 |
| coefficients | | | | |
| 10th order | −1.3421.E+00 | −1.8614.E+00 | −4.8494.E+00 | −2.2733.E+00 |
| coefficients | | | | |
| 12th order | 1.2343.E+01 | −7.1241.E+00 | −5.9310.E+00 | 2.8884.E+00 |
| coefficients | | | | |
| 14th order | −6.0295.E+01 | −1.6946.E+01 | −3.2645.E+00 | 8.0466.E+00 |
| coefficients | | | | |
| 16th order | 3.6680.E−01 | −1.6132.E+00 | −1.9918.E+01 | −6.8902.E+00 |
| coefficients | | | | |
| | 6 | 7 | 8 | 9 |
| Conic | −3.1123.E−01 | −1.8537.E+00 | −1.8537.E+00 | 2.7280.E+00 |
| constant(k) | | | | |
| 4th order | −3.2131.E+00 | −5.3945.E−01 | −5.3945.E−01 | 3.6657.E−01 |
| coefficients | | | | |
| 6th order | 2.9880.E+01 | −2.0458.E+00 | −2.0458.E+00 | −3.1900.E+00 |
| coefficients | | | | |
| 8th order | 3.5221.E−01 | −4.2619.E−01 | −4.2619.E−01 | −9.2862.E−01 |
| coefficients | | | | |
| 10th order | −1.9083.E+00 | 6.3160.E−02 | 6.3160.E−02 | 1.2326.E+00 |
| coefficients | | | | |
| 12th order | −1.6797.E+00 | −6.3539.E−01 | −6.3539.E−01 | −8.4811.E−01 |
| coefficients | | | | |
| 14th order | 1.6765.E+00 | −7.1841.E−01 | −7.1841.E−01 | 2.1181.E−02 |
| coefficients | | | | |
| 16th order | 9.5824.E+00 | 3.5921.E+00 | 3.5921.E+00 | 3.3831.E−01 |
| coefficients | | | | |

The values of the parameters of each condition are as follows.

TABLE 7

| Item | Number |
|---|---|
| f | 1.47 |
| Fno | 2.00 |
| OAL | 2.12 |
| IH | 1.18 |
| EfD1 | 0.74 |
| Half FOV | 38.45 |
| EP | 0.00 |
| EXP | −1.40 |
| f12 | 2.37 |
| f3 | −5.54 |
| f4 | 1.16 |
| f5 | −1.75 |
| N1 | 1.5350 |
| N2 | 1.6652 |
| N3 | 1.5350 |
| N4 | 1.6652 |

TABLE 8

| | Conditional | | Lower | Upper |
|---|---|---|---|---|
| | expression | Number | limit | limit |
| (1) | f/f1 | 0.622 | 0.5 | 1.4 |
| (2) | \|f4/f1\| | 0.737 | 0.4 | 2.0 |
| (3) | N1 < N4 | Refer to | | |
| | | Table 7 | | |
| (4) | N1 | 1.535 | 1.49 | 1.55 |
| (5) | N4 | 1.665 | 1.63 | 1.67 |
| (6) | f/OAL | 0.694 | 0.6 | 0.9 |
| (7) | OAL/EfD1 | 2.881 | 2.2 | 3.2 |
| (8) | EXP/IH | −1.182 | −1.3 | −0.9 |
| (9) | \|f1/f2\| | 0.427 | 0.40 | 0.71 |
| (10) | f3/f1 | 0.492 | 0.30 | 2.80 |
| (11) | \|f3/f4\| | 0.667 | 0.5 | 2.0 |
| (12) | \|f4/f2\| | 0.315 | 0.20 | 1.30 |
| (13) | \|f3/f2\| | 0.210 | 0.10 | 1.50 |
| (14) | OAL/2*IH | 0.898 | 0.70 | 1.00 |

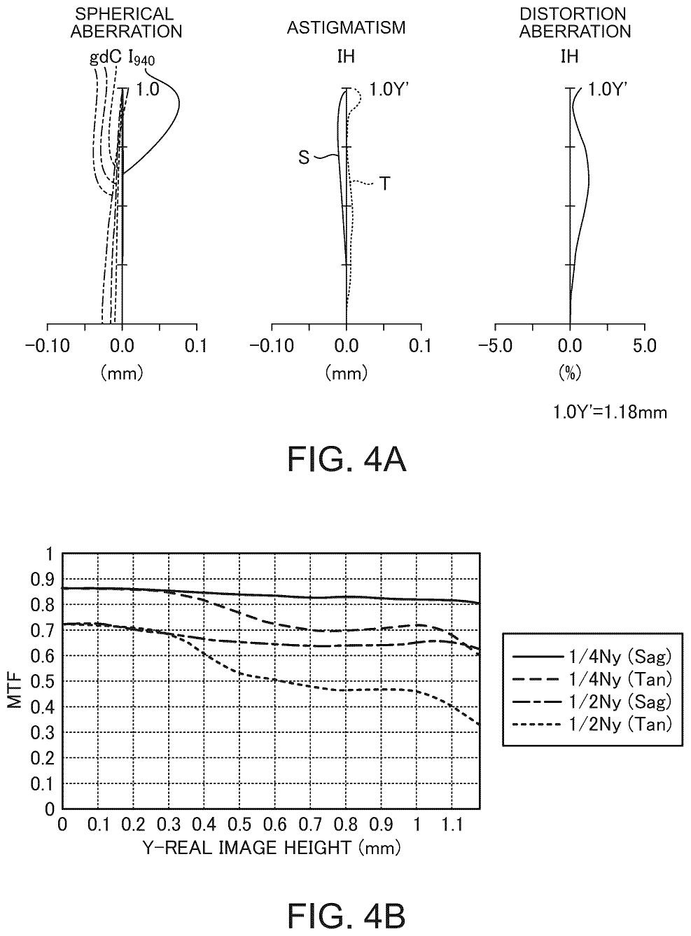

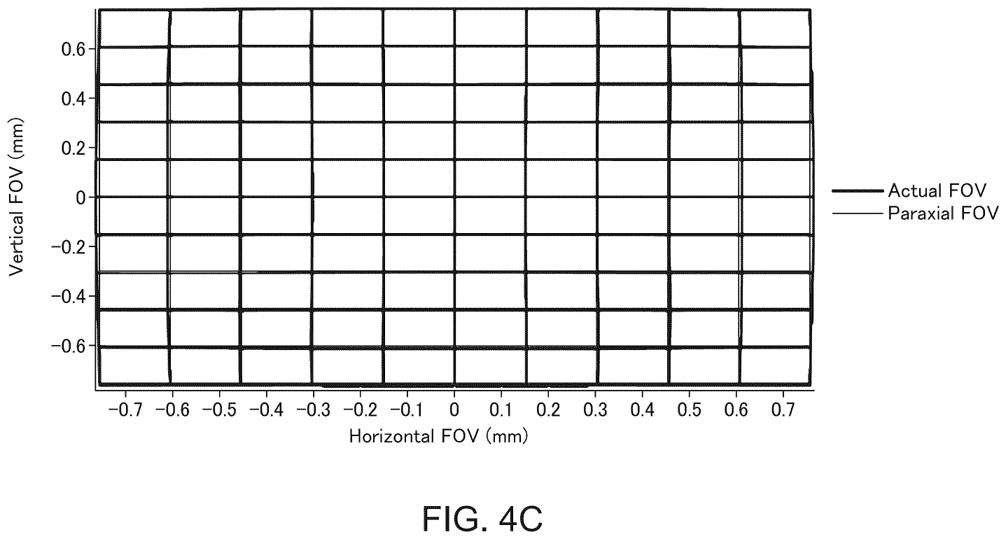

These aberration diagrams, MTFs, and distortion grids are illustrated in FIGS. 4A to 4C, and as is clear from each drawing, the performance is good.

### Example 3

f=1.5 mm, FNo.=2.0, HFOV=38.5⁰

Table 9 illustrates the data from Example 3.

TABLE 9

| No | R | D | Nd | Vd | SD | fl |
|---|---|---|---|---|---|---|
| 1 | — | −0.06 | | | 0.37 | |
| 2 | 0.781 | 0.399 | 1.5350 | 55.71 | 0.39 | 1.3 |
| 3 | −3.709 | 0.100 | | | 0.45 | |
| 4 | −2.194 | 0.200 | 1.6652 | 29.43 | 0.45 | −2.0 |
| 5 | 2.973 | 0.102 | | | 0.47 | |
| 6 | −3.138 | 0.326 | 1.6652 | 29.43 | 0.48 | 1.0 |
| 7 | −0.526 | 0.103 | | | 0.64 | |
| 8 | 1.066 | 0.165 | 1.6652 | 29.43 | 0.89 | −1.0 |
| 9 | 0.367 | 0.257 | | | 1.02 | |
| 10 | — | 0.21 | 1.516798 | 64.20 | 1.05 | — |
| 11 | — | 0.1 | | | 1.10 | |
| 12 | — | — | | | | |

The aspherical data is illustrated below.

TABLE 10

| | 2 | 3 | 4 | 5 |
|---|---|---|---|---|
| Conic | 1.2799.E+00 | −2.6960.E−01 | −4.5574.E−01 | 3.3639.E−01 |
| constant(k) | | | | |
| 4th order | 7.8131.E−01 | −3.7092.E+00 | −2.1943.E+00 | 2.9727.E+00 |
| coefficients | | | | |
| 6th order | −8.9343.E−01 | 6.2204.E+01 | 1.4999.E+01 | 3.4851.E+01 |
| coefficients | | | | |
| 8th order | 2.4811.E−02 | −1.7425.E+00 | −2.8562.E+00 | −1.0562.E+00 |
| coefficients | | | | |
| 10th order | −2.7261.E+00 | −7.1654.E−01 | 3.9814.E+00 | 1.1270.E−01 |
| coefficients | | | | |
| 12th order | 1.5928.E+01 | −4.2862.E−01 | 2.8579.E+01 | 1.2548.E+01 |
| coefficients | | | | |
| 14th order | −1.3141.E+02 | 2.7600.E+01 | 7.1080.E+01 | −5.4371.E+00 |
| coefficients | | | | |
| | 6 | 7 | 8 | 9 |
| Conic | −3.1866.E−01 | −1.9013.E+00 | 9.3788.E−01 | 2.7253.E+00 |
| constant(k) | | | | |
| 4th order | −3.1381.E+00 | −5.2597.E−01 | 1.0662.E+00 | 3.6693.E−01 |
| coefficients | | | | |
| 6th order | 4.0125.E+01 | −3.0241.E+00 | −6.2850.E+01 | −5.8089.E+00 |
| coefficients | | | | |
| 8th order | 1.5047.E+00 | 1.0370.E+00 | −6.5316.E−01 | −7.9248.E−01 |
| coefficients | | | | |
| 10th order | −2.9764.E+00 | 7.6522.E−01 | 5.5039.E−01 | 1.4081.E+00 |
| coefficients | | | | |
| 12th order | −1.2070.E+01 | −4.1957.E+00 | 9.1820.E−01 | −1.6093.E+00 |
| coefficients | | | | |
| 14th order | 2.5484.E+01 | −4.2899.E+00 | −7.3029.E−01 | 4.5642.E−01 |
| coefficients | | | | |

The values of the parameters of each condition are as follows.

TABLE 11

| Item | Number |
|---|---|
| f | 1.46 |
| Fno | 2.00 |
| OAL | 1.90 |
| IH | 1.18 |
| EfD1 | 0.73 |
| Half FOV | 38.45 |
| EP | 0.00 |
| EXP | −1.17 |
| f12 | 1.26 |
| f3 | −1.97 |
| f4 | 0.95 |
| f5 | −0.97 |
| N1 | 1.5350 |
| N2 | 1.6652 |
| N3 | 1.6652 |
| N4 | 1.6652 |

TABLE 12

| | Conditional | | Lower | Upper |
|---|---|---|---|---|
| | expression | Number | limit | limit |
| (1) | f/f1 | 1.158 | 0.5 | 1.4 |
| (2) | \|f4/f1\| | 0.770 | 0.4 | 2.0 |
| (3) | N1 < N4 | Refer to | | |
| | | Table 11 | | |
| (4) | N1 | 1.535 | 1.49 | 1.55 |
| (5) | N4 | 1.665 | 1.63 | 1.67 |
| (6) | f/OAL | 0.770 | 0.6 | 0.9 |
| (7) | OAL/EfD1 | 2.598 | 2.2 | 3.2 |
| (8) | EXP/IH | −0.992 | −1.3 | −0.9 |
| (9) | \|f1/f2\| | 0.643 | 0.40 | 0.71 |
| (10) | f3/f1 | 0.753 | 0.30 | 2.80 |
| (11) | \|f3/f4\| | 0.979 | 0.5 | 2.0 |
| (12) | \|f4/f2\| | 0.495 | 0.20 | 1.30 |
| (13) | \|f3/f2\| | 0.485 | 0.10 | 1.50 |
| (14) | OAL/2*IH | 0.806 | 0.70 | 1.00 |

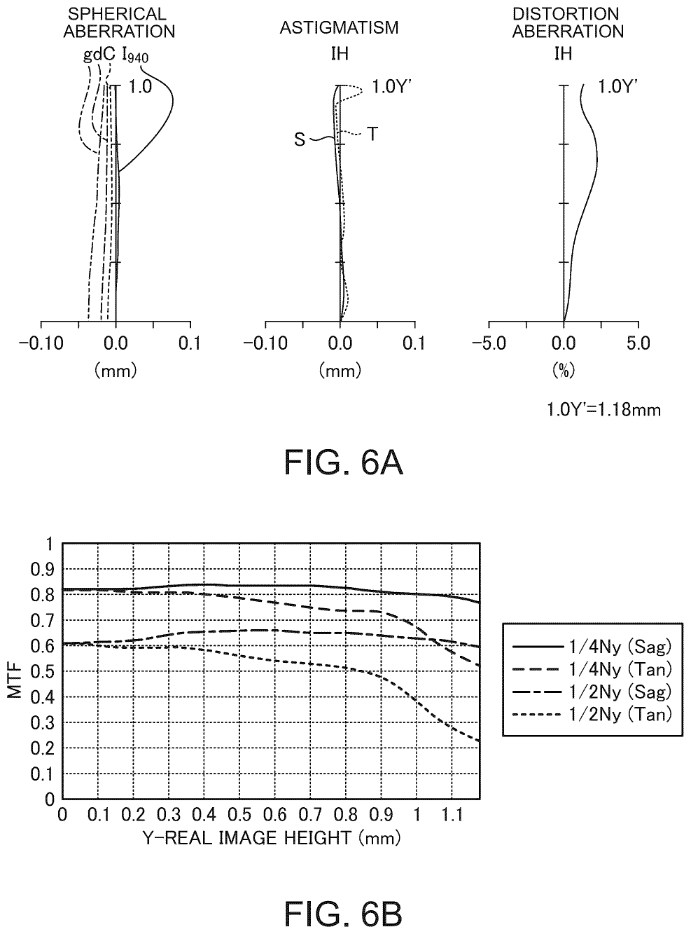

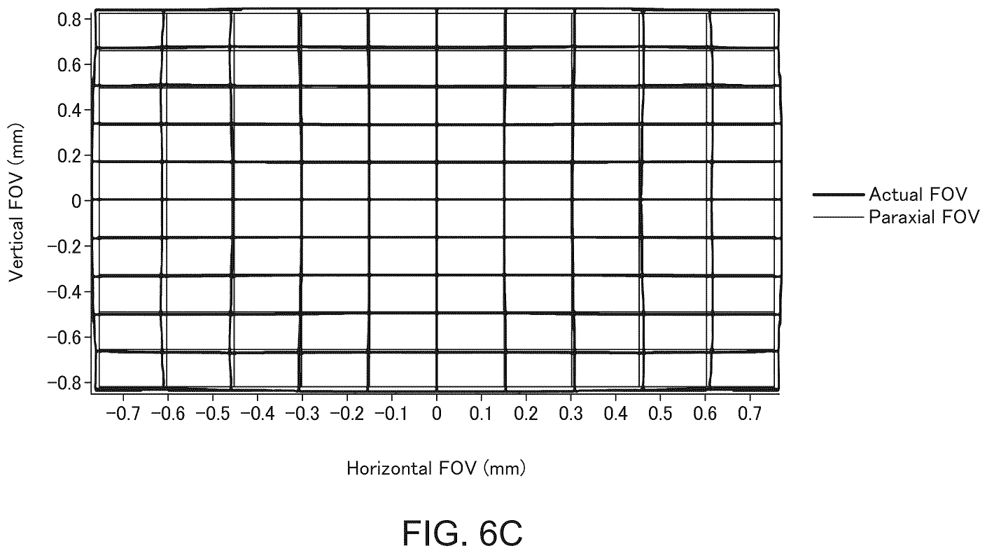

These aberration diagrams, MTFs, and distortion grids are illustrated in FIGS. 6A to 6C, and as is clear from each drawing, the performance is good.

### Example 4

f=1.5 mm, FNo.=2.0, HFOV=38.5⁰

Table 13 illustrates the data from Example 4.

TABLE 13

| No | R | D | Nd | Vd | SD | fl |
|---|---|---|---|---|---|---|
| 1 | — | −0.07 | | | 0.37 | |
| 2 | 0.824 | 0.358 | 1.5350 | 55.71 | 0.38 | 1.5 |
| 3 | −10.318 | 0.100 | | | 0.43 | |
| 4 | −3.142 | 0.200 | 1.6328 | 23.29 | 0.43 | −2.1 |
| 5 | 2.261 | 0.100 | | | 0.49 | |
| 6 | −2.842 | 0.284 | 1.6328 | 23.29 | 0.50 | 1.3 |
| 7 | −0.652 | 0.194 | | | 0.58 | |
| 8 | 0.812 | 0.200 | 1.6328 | 23.29 | 0.89 | −1.9 |
| 9 | 0.437 | 0.271 | | | 1.05 | |
| 10 | — | 0.21 | 1.516798 | 64.20 | 1.08 | — |
| 11 | — | 0.1 | | | 1.12 | |
| 12 | — | — | | | | |

The aspherical data is illustrated below.

TABLE 14

| | 2 | 3 | 4 | 5 |
|---|---|---|---|---|
| Conic | 1.2138.E+00 | −9.6920.E−02 | −3.1828.E−01 | 4.4231.E−01 |
| constant(k) | | | | |
| 4th order | 8.2387.E−01 | −1.0318.E+01 | −3.1419.E+00 | 2.2609.E+00 |
| coefficients | | | | |
| 6th order | −8.4752.E−01 | 2.5000.E+02 | −1.1602.E+01 | 3.5725.E−01 |
| coefficients | | | | |
| 8th order | 3.0347.E−02 | −1.2891.E+00 | −2.7168.E+00 | −8.6962.E−01 |
| coefficients | | | | |
| 10th order | −1.2441.E+00 | −2.9838.E+00 | −3.2145.E+00 | −2.2452.E+00 |
| coefficients | | | | |
| 12th order | 1.2262.E+01 | −8.6065.E+00 | 1.2919.E+01 | 1.1201.E+00 |
| coefficients | | | | |
| 14th order | −1.1143.E+02 | 2.4451.E+01 | 7.1409.E+01 | 2.0942.E+00 |
| coefficients | | | | |
| | 6 | 7 | 8 | 9 |
| Conic | −3.5190.E−01 | −1.5344.E+00 | 1.2322.E+00 | 2.2871.E+00 |
| constant(k) | | | | |
| 4th order | −2.8417.E+00 | −6.5171.E−01 | 8.1154.E−01 | 4.3724.E−01 |
| coefficients | | | | |
| 6th order | 2.9354.E+01 | −2.0166.E+00 | −1.2735.E+01 | −4.4260.E+00 |
| coefficients | | | | |
| 8th order | 1.3029.E+00 | 1.6537.E−01 | −9.9246.E−01 | −7.6598.E−01 |
| coefficients | | | | |
| 10th order | −2.7947.E+00 | 1.9711.E+00 | 6.0489.E−01 | 1.0254.E+00 |
| coefficients | | | | |
| 12th order | −5.7015.E+00 | 3.0587.E−01 | 1.4408.E+00 | −8.8066.E−01 |
| coefficients | | | | |
| 14th order | 6.3717.E−01 | −3.8197.E+00 | −7.6013.E−01 | 2.1459.E−01 |
| coefficients | | | | |

The values of the parameters of each condition are as follows.

TABLE 15

| Item | Number |
|---|---|
| f | 1.46 |
| Fno | 2.00 |
| OAL | 1.95 |
| IH | 1.18 |
| EfD1 | 0.73 |
| Half FOV | 38.45 |
| EP | 0.00 |
| EXP | −1.17 |
| f12 | 1.47 |
| f3 | −2.12 |
| f4 | 1.32 |
| f5 | −1.95 |
| N1 | 1.5350 |
| N2 | 1.6328 |
| N3 | 1.6328 |
| N4 | 1.6328 |

TABLE 16

| | Conditional | | Lower | Upper |
|---|---|---|---|---|
| | expression | Number | limit | limit |
| (1) | f/f1 | 0.999 | 0.5 | 1.4 |
| (2) | \|f4/f1\| | 1.329 | 0.4 | 2.0 |
| (3) | N1 < N4 | Refer to | | |
| | | Table 15 | | |
| (4) | N1 | 1.535 | 1.49 | 1.55 |
| (5) | N4 | 1.633 | 1.63 | 1.67 |
| (6) | f/OAL | 0.752 | 0.6 | 0.9 |
| (7) | OAL/EfD1 | 2.660 | 2.2 | 3.2 |
| (8) | EXP/IH | −0.989 | −1.3 | −0.9 |
| (9) | \|f1/f2\| | 0.690 | 0.40 | 0.71 |
| (10) | f3/f1 | 0.901 | 0.30 | 2.80 |
| (11) | \|f3/f4\| | 0.678 | 0.5 | 2.0 |
| (12) | \|f4/f2\| | 0.917 | 0.20 | 1.30 |
| (13) | \|f3/f2\| | 0.622 | 0.10 | 1.50 |
| (14) | OAL/2*IH | 0.825 | 0.70 | 1.00 |

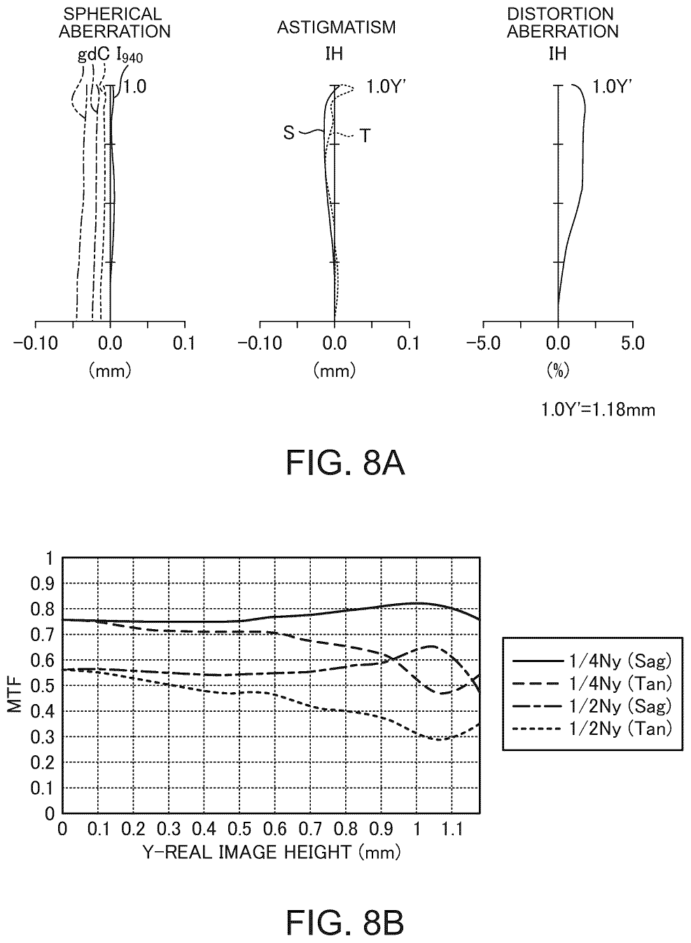

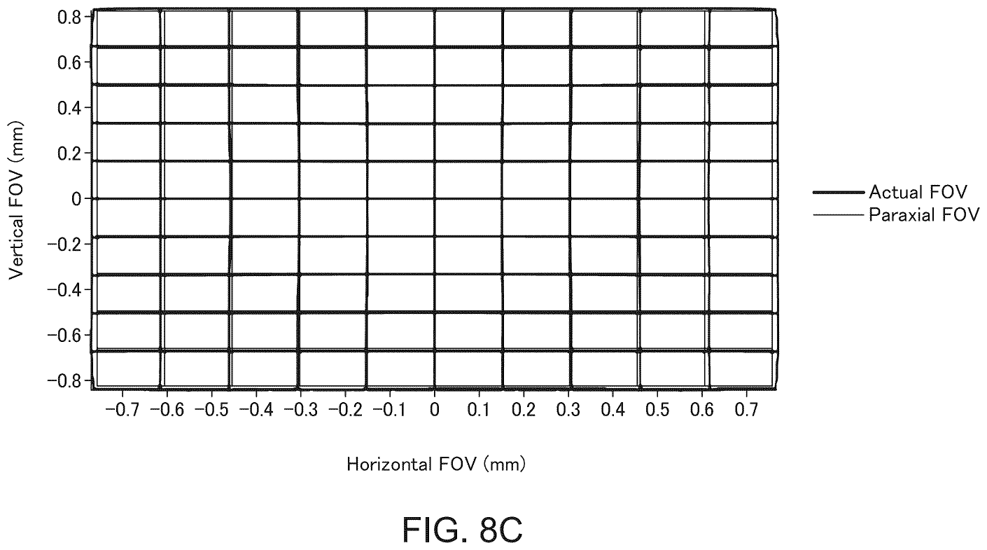

These aberration diagrams, MTFs, and distortion grids are illustrated in FIGS. 8A to 8C, and as is clear from each aberration diagram, the performance is good.

### Example 5

f=1.4 mm, FNo.=2.0, HFOV=38.5⁰

Table 17 illustrates the data from Example 5.

TABLE 17

| No | R | D | Nd | Vd | SD | fl |
|---|---|---|---|---|---|---|
| 1 | — | −0.07 | | | 0.36 | |
| 2 | 0.788 | 0.393 | 1.5168 | 64.20 | 0.38 | 1.5 |
| 3 | −11.444 | 0.100 | | | 0.43 | |
| 4 | −1.448 | 0.200 | 1.6328 | 23.29 | 0.43 | −2.6 |
| 5 | −21.032 | 0.100 | | | 0.50 | |
| 6 | −3.042 | 0.241 | 1.6328 | 23.29 | 0.50 | 1.6 |
| 7 | −0.777 | 0.165 | | | 0.58 | |
| 8 | 0.764 | 0.216 | 1.6328 | 23.29 | 0.90 | −2.8 |
| 9 | 0.471 | 0.285 | | | 1.06 | |
| 10 | — | 0.21 | 1.516798 | 64.20 | 1.08 | — |
| 11 | — | 0.1 | | | 1.12 | |
| 12 | — | — | | | | |

The aspherical data is illustrated below.

TABLE 18

| | 2 | 3 | 4 | 5 |
|---|---|---|---|---|
| Conic | 0.0000.E+00 | 0.0000.E+00 | −6.9042.E−01 | −4.7546.E−02 |
| constant(k) | | | | |
| 4th order | 0.0000.E+00 | 0.0000.E+00 | −1.4484.E+00 | −2.1032.E+01 |
| coefficients | | | | |
| 6th order | 0.0000.E+00 | 0.0000.E+00 | −2.3063.E+01 | −4.6466.E+04 |
| coefficients | | | | |
| 8th order | 0.0000.E+00 | 0.0000.E+00 | −1.3026.E+00 | −2.6962.E−01 |
| coefficients | | | | |
| 10th order | 0.0000.E+00 | 0.0000.E+00 | 6.3384.E−01 | −2.5495.E+00 |
| coefficients | | | | |
| 12th order | 0.0000.E+00 | 0.0000.E+00 | 9.9831.E+00 | −5.8237.E−01 |
| coefficients | | | | |
| 14th order | 0.0000.E+00 | 0.0000.E+00 | 4.2329.E+01 | 2.8579.E−01 |
| coefficients | | | | |
| | 6 | 7 | 8 | 9 |
| Conic | −3.2878.E−01 | −1.2868.E+00 | 1.3088.E+00 | 2.1238.E+00 |
| constant(k) | | | | |
| 4th order | −3.0415.E+00 | −7.7713.E−01 | 7.6406.E−01 | 4.7085.E−01 |
| coefficients | | | | |
| 6th order | 2.9018.E+01 | −2.0988.E+00 | −8.2356.E+00 | −3.9339.E+00 |
| coefficients | | | | |
| 8th order | 9.1646.E−01 | 1.6120.E−01 | −9.0806.E−01 | −7.4526.E−01 |
| coefficients | | | | |
| 10th order | −3.1281.E+00 | 1.8554.E+00 | 4.9260.E−01 | 1.0080.E+00 |
| coefficients | | | | |
| 12th order | −2.4230.E+00 | −6.6058.E−02 | 1.3465.E+00 | −9.1365.E−01 |
| coefficients | | | | |
| 14th order | 1.1655.E+01 | −4.4950.E+00 | −6.2739.E−01 | 2.5333.E−01 |
| coefficients | | | | |

The values of the parameters of each condition are as follows.

TABLE 19

| Item | Number |
|---|---|
| f | 1.44 |
| Fno | 2.00 |
| OAL | 1.94 |
| IH | 1.18 |
| EfD1 | 0.72 |
| Half FOV | 38.45 |
| EP | 0.00 |
| EXP | −1.21 |
| f12 | 1.47 |
| f3 | −2.56 |
| f4 | 1.64 |
| f5 | −2.79 |
| N1 | 1.5168 |
| N2 | 1.6328 |
| N3 | 1.6328 |
| N4 | 1.6328 |

TABLE 20

| | Conditional | | Lower | Upper |
|---|---|---|---|---|
| | expression | Number | limit | limit |
| (1) | f/f1 | 0.982 | 0.5 | 1.4 |
| (2) | \|f4/f1\| | 1.902 | 0.4 | 2.0 |
| (3) | N1 < N4 | Refer to | | |
| | | Table 19 | | |
| (4) | N1 | 1.517 | 1.49 | 1.55 |
| (5) | N4 | 1.633 | 1.63 | 1.67 |
| (6) | f/OAL | 0.742 | 0.6 | 0.9 |
| (7) | OAL/EfD1 | 2.695 | 2.2 | 3.2 |
| (8) | EXP/IH | −1.025 | −1.3 | −0.9 |
| (9) | \|f1/f2\| | 0.573 | 0.40 | 0.71 |
| (10) | f3/f1 | 1.121 | 0.30 | 2.80 |
| (11) | \|f3/f4\| | 0.589 | 0.5 | 2.0 |
| (12) | \|f4/f2\| | 1.090 | 0.20 | 1.30 |
| (13) | \|f3/f2\| | 0.643 | 0.10 | 1.50 |
| (14) | OAL/2*IH | 0.822 | 0.70 | 1.00 |

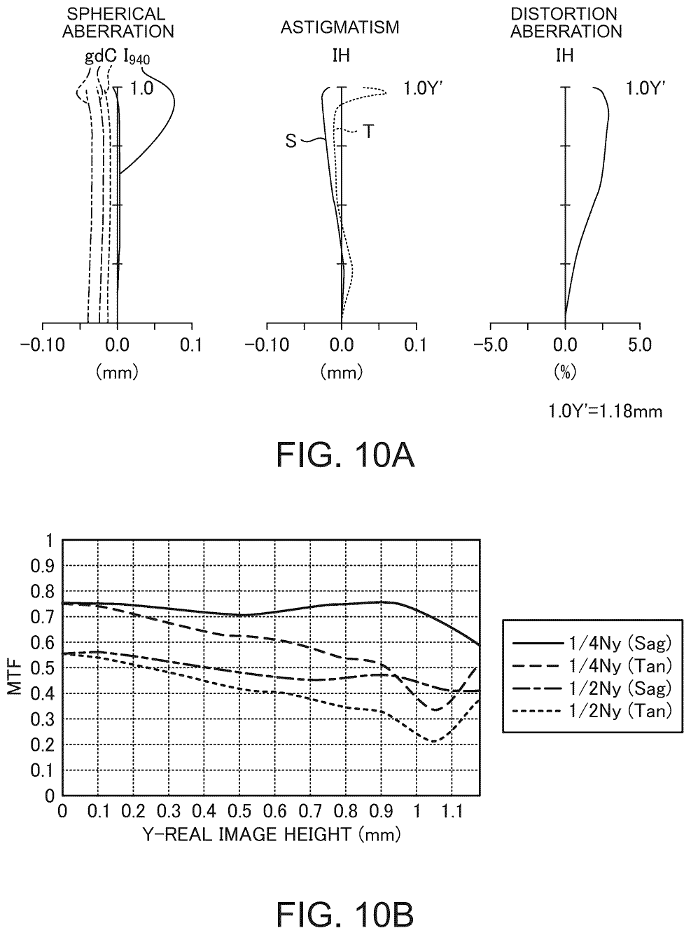

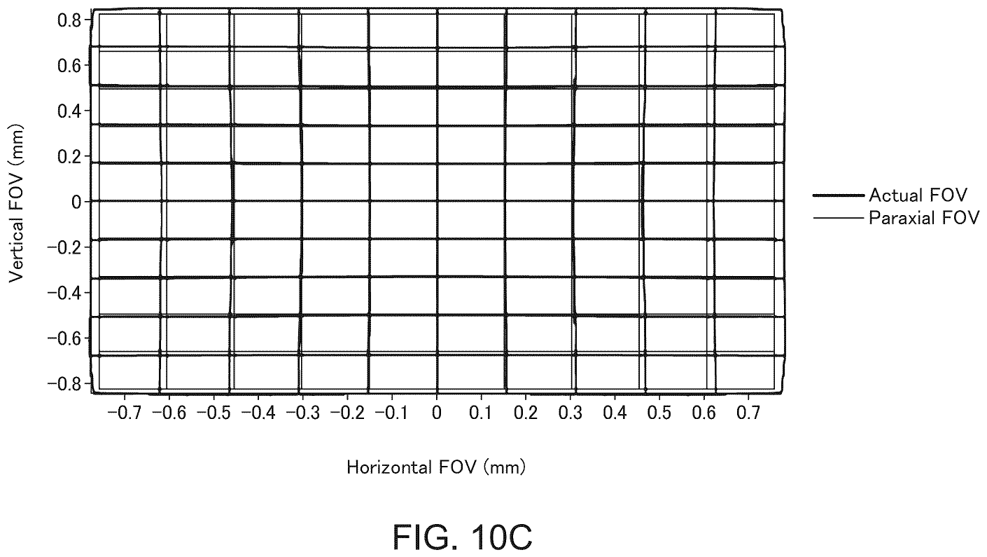

These aberration diagrams, MTFs, and distortion grids are illustrated in FIGS. 10A to 10C, and as is clear from each aberration diagram, the performance is good.

### Example 6

f=1.9 mm, FNo.=2.0, HFOV=32.4⁰

Table 21 illustrates the data from Example 6.

TABLE 21

| No | R | D | Nd | Vd | SD | fl |
|---|---|---|---|---|---|---|
| 1 | — | −0.14 | | | 0.46 | |
| 2 | 0.736 | 0.489 | 1.5168 | 64.20 | 0.48 | 1.4 |
| 3 | −53.439 | 0.100 | | | 0.48 | |
| 4 | −2.011 | 0.200 | 1.6328 | 23.29 | 0.47 | −3.4 |
| 5 | −64.345 | 0.187 | | | 0.49 | |
| 6 | −3.201 | 0.200 | 1.6328 | 23.29 | 0.52 | 4.0 |
| 7 | −1.409 | 0.102 | | | 0.67 | |
| 8 | 2.840 | 0.471 | 1.6328 | 23.29 | 0.85 | −2.6 |
| 9 | 0.960 | 0.200 | | | 1.10 | |
| 10 | — | 0.21 | 1.516798 | 64.20 | 1.13 | — |
| 11 | — | 0.1 | | | 1.15 | |
| 12 | — | — | | | | |

The aspherical data is illustrated below.

TABLE 22

| | 2 | 3 | 4 | 5 |
|---|---|---|---|---|
| Conic | 0.0000.E+00 | 0.0000.E+00 | −4.9733.E−01 | −1.5541.E−02 |
| constant(k) | | | | |
| 4th order | 0.0000.E+00 | 0.0000.E+00 | −2.0107.E+00 | −6.4345.E+01 |
| coefficients | | | | |
| 6th order | 0.0000.E+00 | 0.0000.E+00 | −2.0300.E+01 | −1.0428.E+07 |
| coefficients | | | | |
| 8th order | 0.0000.E+00 | 0.0000.E+00 | −3.9147.E−01 | 3.5170.E−01 |
| coefficients | | | | |
| 10th order | 0.0000.E+00 | 0.0000.E+00 | 2.0883.E−01 | −2.2105.E+00 |
| coefficients | | | | |
| 12th order | 0.0000.E+00 | 0.0000.E+00 | −6.7229.E+00 | 4.8144.E+00 |
| coefficients | | | | |
| 14th order | 0.0000.E+00 | 0.0000.E+00 | 9.1109.E+01 | 9.4620.E+00 |
| coefficients | | | | |
| 16th order | 0.0000.E+00 | 0.0000.E+00 | −3.0641.E+02 | −1.0474.E+01 |
| coefficients | | | | |
| | 6 | 7 | 8 | 9 |
| Conic | −3.1240.E−01 | −7.0986.E−01 | 3.5207.E−01 | 1.0421.E+00 |
| constant(k) | | | | |
| 4th order | −3.2011.E+00 | −1.4087.E+00 | 2.8404.E+00 | 9.5957.E−01 |
| coefficients | | | | |
| 6th order | 3.6971.E+01 | −1.5061.E+01 | −5.2876.E+01 | −5.2130.E+00 |
| coefficients | | | | |
| 8th order | 1.4072.E+00 | 5.5095.E−01 | −6.6320.E−01 | −6.6899.E−01 |
| coefficients | | | | |
| 10th order | −4.4833.E+00 | 9.5552.E−01 | 1.0798.E+00 | 1.1404.E+00 |
| coefficients | | | | |
| 12th order | 5.0454.E−02 | −3.1203.E+00 | 7.7495.E−01 | −1.2345.E+00 |
| coefficients | | | | |
| 14th order | 1.2784.E+01 | −6.1782.E+00 | −1.7290.E+00 | 1.8374.E−01 |
| coefficients | | | | |
| 16th order | 1.6761.E+01 | 2.0414.E+00 | −1.6363.E+00 | 6.6821.E−01 |
| coefficients | | | | |

The values of the parameters of each condition are as follows.

TABLE 23

| Item | Number |
|---|---|
| f | 1.83 |
| Fno | 2.00 |
| OAL | 2.12 |
| IH | 1.19 |
| EfD1 | 0.91 |
| Half FOV | 32.42 |
| EP | 0.00 |
| EXP | −1.13 |
| f12 | 1.43 |
| f3 | −3.40 |
| f4 | 3.95 |
| f5 | −2.62 |
| N1 | 1.5168 |
| N2 | 1.6328 |
| N3 | 1.6328 |
| N4 | 1.6328 |

TABLE 24

| | Conditional | | Lower | Upper |
|---|---|---|---|---|
| | expression | Number | limit | limit |
| (1) | f/f1 | 1.278 | 0.5 | 1.4 |
| (2) | \|f4/f1\| | 1.831 | 0.4 | 2.0 |
| (3) | N1 < N4 | Refer to | | |
| | | Table 23 | | |
| (4) | N1 | 1.517 | 1.49 | 1.55 |
| (5) | N4 | 1.633 | 1.63 | 1.67 |
| (6) | f/OAL | 0.863 | 0.6 | 0.9 |
| (7) | OAL/EfD1 | 2.317 | 2.2 | 3.2 |
| (8) | EXP/IH | −0.949 | −1.3 | −0.9 |
| (9) | \|f1/f2\| | 0.421 | 0.40 | 0.71 |
| (10) | f3/f1 | 2.761 | 0.30 | 2.80 |
| (11) | \|f3/f4\| | 1.508 | 0.5 | 2.0 |
| (12) | \|f4/f2\| | 0.770 | 0.20 | 1.30 |
| (13) | \|f3/f2\| | 1.162 | 0.10 | 1.50 |
| (14) | OAL/2*IH | 0.892 | 0.70 | 1.00 |

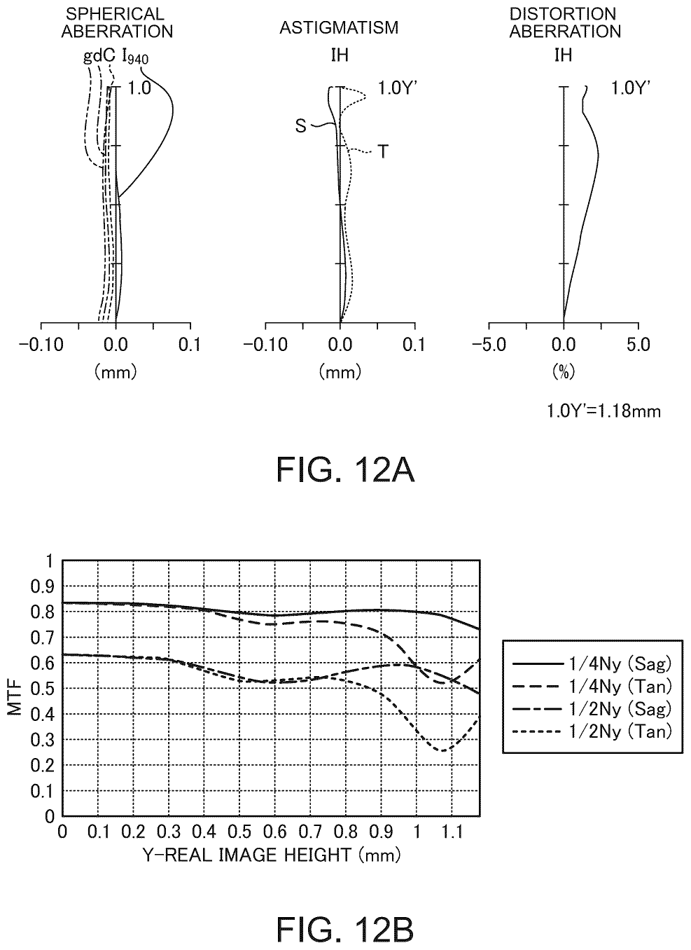

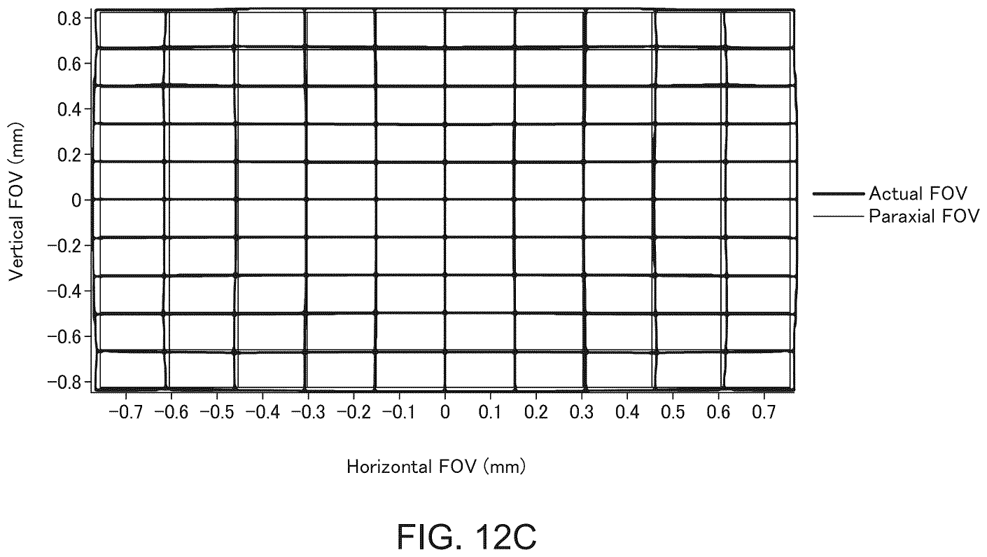

These aberration diagrams, MTFs, and distortion grids are illustrated in FIGS. 12A to 12C, and as is clear from each aberration diagram, the performance is good.

Hereinbefore, as illustrated in Examples 1 to 6, and FIGS. 2A to 2C, FIGS. 4A to 4C, FIGS. 6A to 6C, FIGS. 8A to 8C, FIGS. 10A to 10C, and FIGS. 12A to 12C, the imaging lens 100 of the present disclosure is bright, has high performance, and is miniaturized (shortening in the optical axis direction), realizing a half angle of view of approximately 50° with five lenses, and it is clear that the imaging lens 100 is suitable for use as an imaging device, particularly an imaging device for a laptop PC.

Hereinbefore, although several embodiments of the present application have been described in detail with reference to the drawings, these are merely examples. The present invention can be implemented in other embodiments with various modifications and improvements based on the knowledge of those skilled in the art, including the aspects described in the disclosure of the present invention.

### DESCRIPTION OF SYMBOLS

30 information processing apparatus
31 recognition device
100 imaging lens
L1 first lens
L2 second lens
L3 third lens
L4 fourth lens
S aperture stop
CG cover glass

What is claimed is:

1. An imaging lens, comprising:
a first lens, a second lens, a third lens, and a fourth lens disposed in order from an object side; and
an aperture stop disposed on a foremost object side, wherein
the first lens is a positive lens having a convex surface facing the object side,
the second lens is a negative lens having an inflection point on at least one surface with a low thickness deviation ratio,
the third lens is a positive lens having a convex surface facing an image plane side and an inflection point on a lens peripheral portion on a surface on the object side,
the fourth lens is a negative lens having a concave surface on an image plane side and an inflection point on a peripheral portion, and
Conditions (1) and (2) are satisfied,
$$0.5 < \vert f / f 1 \vert < 1.4 and \qquad ( 1 )$$
$$0.4 < \vert f 4 / f 1 \vert < 2. , \qquad ( 2 )$$
when a focal length of the first lens is denoted by f1, a focal length of the fourth lens is denoted by f4, and a focal length of an entire optical system is denoted by f.

2. The imaging lens according to claim 1, wherein
each of the first lens to the fourth lens has a near-infrared region compatible coating corresponding to near-infrared rays applied onto a lens surface on at least one surface or more, and
the near-infrared region compatible coating transmits light in a band of 450 to 940 nm and has reflectivity of 2% or less in a band of at least a near-infrared region of 850 nm to 940 nm.

3. The imaging lens according to claim 1, wherein
Condition (3) is satisfied,
$$N 1 < N 4 , \qquad ( 3 )$$
when a refractive index of a material of the first lens with respect to a d-line is denoted by N1 and a refractive index of a material of the fourth lens with respect to the d-line is denoted by N4.

4. The imaging lens according to claim 1, wherein
Condition (4) is satisfied,
$$1.49 < N 1 < 1.55 , \qquad ( 4 )$$
when a refractive index of a material of the first lens with respect to a d-line is denoted by N1.

5. The imaging lens according to claim 1, wherein
Condition (5) is satisfied,
$$1.63 < N 4 < 1.67 , \qquad ( 5 )$$
when a refractive index of a material of the fourth lens with respect to a d-line is denoted by N4.

6. The imaging lens according to claim 1, wherein
Condition (6) is satisfied,
$$0.6 < f / OAL < 0.9 , \qquad ( 6 )$$
when the focal length of the entire optical system is denoted by f and a total length of an optical system is denoted by OAL.

7. The imaging lens according to claim 1, wherein
Condition (7) is satisfied,
$$2.2 < OAL / EfD 1 < 3.2 , \qquad ( 7 )$$
when an optical overall length is denoted by OAL and an optical effective diameter of a lens on the foremost object side is denoted by EfD1.

8. The imaging lens according to claim 1, wherein
Condition (8) is satisfied,
$$- 1.3 < EXP / IH < - 0.9 , \qquad ( 8 )$$
when a position of an exit pupil is denoted by EXP and an image height is denoted by IH.

9. The imaging lens according to claim 1, wherein
Condition (9) is satisfied,
$$0.4 < \vert f 1 / f 2 \vert < 0.71 , \qquad ( 9 )$$
when the focal length of the first lens is denoted by f1 and a focal length of the second lens is denoted by f2.

10. The imaging lens according to claim 1, wherein
Condition (10) is satisfied,
$$0.3 < f 3 / f 1 < 2.8 , \qquad ( 10 )$$
when the focal length of the first lens is denoted by f1 and a focal length of the third lens is denoted by f3.

11. The imaging lens according to claim 1, wherein
Condition (11) is satisfied,
$$0.5 < \vert f 3 / f 4 \vert < 2. , \qquad ( 11 )$$
when a focal length of the third lens is denoted by f3 and the focal length of the fourth lens is denoted by f4.

12. A recognition device, comprising:
the imaging lens according to claim 1; and
a solid-state imaging element configured to receive an image formed by the imaging lens and generate an imaging signal.

13. An information processing apparatus, comprising:
the recognition device according to claim 12; and
a display unit configured to display an image corresponding to the imaging signal generated by the recognition device.
